(19) United States
(12) Patent Application Publication
(10) Pub. No.: US 2026/0197563 A1
(43) Pub. Date: Jul. 9, 2026

(54) METHOD AND DEVICE OF OPTICAL ROUTING IN POLARISATION AND/OR WAVELENGTH OF LIGHT, AND OPTOELECTRONIC DETECTOR INCORPORATING SAME

(71) Applicant: COMMISSARIAT A L'ENERGIE ATOMIQUE ET AUX ENERGIES ALTERNATIVES, Paris (FR)

(72) Inventor: Guillaume CHATAIGNIER, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 19/439,099

(22) Filed: Jan. 2, 2026

(30) Foreign Application Priority Data
Jan. 3, 2025 (FR) FR2500039

(51) Int. Cl. H04N 25/703

(52) U.S. Cl. CPC H04N 25/703

(57) ABSTRACT

An optoelectronic detector includes a device of pixel-level polarization or wavelength routing of incident light, which is formed above a photodetector array. An arrangement of elementary optical routers makes it possible to reduce the disadvantages of reciprocal optical coupling between adjacent pixels while benefiting from the improved sensitivity of the optoelectronic detector offered by optical routing compared to optical filtering. To this end, the routing patterns of two adjacent elementary routers along the light routing direction are arranged mirrored to each other along this direction. Thus, a pixel associated with one of the elementary routers and a pixel associated with the other of the elementary routers, which are dedicated to detecting the same polarization state or the same wavelength, are contiguous along the direction of light routing.

### TECHNICAL FIELD

The present invention relates generally to polarimetric and/or colorimetric imaging, and more specifically to a method and device of polarization and/or wavelength routing of light (i.e. routing based on or dependent on polarisation and/or wavelength), as well as an optoelectronic detector, for example a CMOS image sensor, incorporating said device.

The invention has applications, for example, in vision systems for industrial robotics or in autonomous mobile systems such as, but not limited to, vehicles, robots or drones.

### TECHNOLOGICAL BACKGROUND

Systems of the afore-mentioned type use a polarized vision camera to improve image quality by eliminating reflections, or to enable the detection and/or identification of certain materials with a polarizing effect, or to assist in depth reconstruction (known as ‘z-estimation’).

The principle of polarimetric imaging consists of separately capturing several states of light polarization for a given optical scene. Individual knowledge of the different states of light polarization, generally at least two orthogonal linear polarizations, makes it possible to extract information of interest related to the scene. For example, polarization vision cameras currently used in industry can inspect reflective surfaces such as glass or metal, which is difficult with monochrome or color cameras designed for conventional vision. Ideally, an optoelectronic sensor dedicated to polarization vision should be able to acquire images of the same optical scene for different states of light polarization, simultaneously and from the same viewpoint (without any parallax, whether temporal or spatial), so that the images captured are strictly superimposable.

Vision integrators known in the industry are often used in conjunction with a main optical device forming a polarization filter, fitted to the camera lens. However, by design, this filter can only block polarized light at a specific angle, which is a unique angle as it is defined by the characteristics of the filter as it is implemented in practice.

In the state of the art, CMOS image sensors with global shutter IMX250MZR™, IMX264MZR™ and IMX253MZR™ from the Sony Pregius™ family, manufactured by SONY Inc., are also known. These are integrated optoelectronic devices that use quadruple-polarized monochrome filters to capture light polarized in four planes. These sensors can thus simultaneously capture images of the same scene in four different light directions, corresponding to four respective viewing angles. This solution works by filtering the light. The image sensor is equipped with a polarizing filter, which is a quad-directional polarizer placed on the CMOS sensor's photodiodes, or pixels. This polarizer allows the sensor to capture a quad-directional image in a single shot. Operating electronics then calculate the angle and direction of the polarization in question based on the overall light intensity captured for each of the polarization directions. The filter incorporates a 2×2 pixel pattern, where each of the pixels in a square block of four adjacent pixels is associated with an elementary filter with a respective viewing angle among the four polarization directions taken into account. When used under polarized light, only the portion of light perpendicular to the viewing angle of the filter associated with a given pixel passes through to that pixel, with the rest of the light flux being blocked by the optical filtering effect.

Thus, the characteristics of the polarization filter are as follows:
when the filter blocks light polarized at an angle of 90°, it allows light polarized at an angle of 0° to pass through;
when it blocks light at an angle of 45°, it allows light polarized at an angle of 135° to pass through;
when it blocks light at an angle of 135°, it allows light polarized at an angle of 45° to pass through; and/or, finally,
when it blocks light at an angle of 0°, it allows light polarized at an angle of 90° to pass through.

The term “extinction” is also used to refer to the blocking of the part of the light flux that does not pass through the filter and therefore does not reach the sensitive surface of the CMOS image sensor.

The IMX250MZR™, IMX264MZR™, and IMX253MZR™ polarization camera sensors mentioned above therefore include a polarizing filter, which is positioned under the lens layer integrated into the chip. This improves the angle of incidence and extinction ratio compared to a conventional polarizer arrangement above the lenses, due to the shorter distance between the polarizer and the detection photodiodes. However, these sensors use the principle of polarization filtering. They are based on metal filters. As a result, the sensors offer a high polarization rejection rate. However, quantum efficiency is greatly reduced, as only a very limited portion of the incident optical flux reaches the photodiodes. These sensors therefore have low sensitivity.

The advantage of polarization-based optical routing, compared to the polarization filtering of the sensors discussed above, is that it recovers more light flux and therefore increases the sensitivity of the sensor.

The invention relates to optoelectronic detectors in which the separation of the polarization states of light takes place directly at the sensitive surface of the photoelectric sensor, at the level of the elementary photodetector or pixel. The idea is to cover several pixels, and more specifically at least two pixels that are adjacent in a given direction, known as the routing direction, with a unitary optical element whose role is to route the light according to its polarization state: light with polarization state A is selectively deflected to converge in the associated type A pixel, light with polarization state B is selectively deflected to converge in another associated type B pixel, etc. The optical unit element associated with pixels of types A, B, etc. to ensure this optical routing based on the polarization of light, known as a unit router, has a rectangular or square pattern of format N×M, where N and M are specific integers, which is repeated across the entire surface of the optoelectronic detector. The polarization structure formed by the spatial repetition, in 2D, of the pattern of this unit router in order to cover the surface of the sensor forms a device of routing of light as a function of its polarization state, known as a polarization optical router.

There are no known commercially available optoelectronic products that use such polarization-based optical routers. However, some recent scientific research articles address the subject and propose experimental approaches based on the use of metasurfaces.

The article entitled “Metasurface-based polarization color routers”, by Xiujuan Zou, Guangxing Gong, Yu Lin, Boyan Fu, Shuming Wang, Shining Zhu, and Zhenlin Wang, in the journal Optics and Lasers in Engineering, Volume 163, April 2023, 107472, ISSN 0143-8166 (https://doi.org/10.1016/j.optlaseng.2022. 107472) discloses a polarization color router based on a metasurface, which can simultaneously capture a Bayer pattern (R-G-G-B distribution) under white light with any polarization for color imaging and polarization detection. Unlike a prospective metasurface design, the metasurface discussed in this paper is designed in reverse using a global optimization algorithm (i.e., a generic algorithm) based on the objectives of optically routing all incident light to different output ports. The symmetry of the nanostructure distribution is used to achieve the polarization response, which greatly simplifies the complexity of the polarization structure design. Each elementary cell of the metasurface performs both the functions of focusing and routing light in the optical spectrum under consideration. This overcomes the known problems associated with the low light penetration rate of most conventional color image sensors.

The article entitled “Efficient polarization beam splitter pixels based on a dielectric metasurface” by M. Khorasaninejad, W. Zhu, and K. B. Crozier, Optica Vol. 2, Issue 4, pp. 376-382, 2015 (https://doi.org/10.1364/OPTICA.2.000376), discloses a concept for a new method for pixel-level polarimetry. Each pixel contains amorphous silicon nanoparticles and deflects incident light depending on polarization. Since photons are distributed according to polarization rather than filtered, the approach achieves high efficiency, i.e., high sensor sensitivity.

The article entitled “Efficient polarization beam splitter pixels based on a dielectric metasurface,” by Shuwen Wei, Zhenyu Yang, and Ming Zhao, Optics Letters 2017, Vol. 42, Issue 8, pp. 1580-1583, (https://doi.org/10.1364/OL.42.001580) describes an ultra-compact polarizer based on dielectric metasurfaces. The basic optical element of the metasurface proposed in the article consists of four zones arranged in a specific pattern. Each zone acts not only as a polarization separator, but also as a flat focusing lens. Thus, it can acquire a certain polarization component of the incident light and focus it on the associated receiver. As a result, the Stokes parameters of the incident light can be immediately determined using the data from the receiver.

However, known router-based solutions raise the issue of mutual coupling, also known as crosstalk, between different states of light polarization. This is because pixels sensitive to different polarizations are adjacent (i.e., contiguous) on the surface of the optical detector, so that inherent imperfections in routing result in a neighboring pixel receiving some of the light that is supposed to be routed to each given pixel. This problem already exists in the case of normal incidence illumination (i.e., orthogonal to the sensitive surface of the optical detector) and is further exacerbated when considering a different angle of incidence of light, defined by the aperture of the main optics that may be placed in front of the optical detector.

Polarization filters, i.e., devices based on optical filtering according to the polarization of light, such as those presented first in the above (with particular reference to the aforementioned sensors from Sony Inc.), are much less affected by this problem of mutual coupling. This is because each optical filter element must not allow light to pass anywhere other than into the pixel located directly below it, orthogonally. The prior art relating to this type of device is therefore of little relevance to the problem at hand, which concerns cross-coupling between adjacent pixels.

Work has also been done on the ideal placement of color filters (typically red, green, and blue) on a CMOS sensor in conventional color imaging. In general, this work does not take into account, strictly speaking, the reciprocal coupling between pixels dedicated to respective colors, but aims at advanced functions such as better reconstruction of each color, better spatial resolution, easier demosaicing of the electrical signals generated, etc. Examples include the “quad-Bayer” sensors from SAMSUNG and SONY, and the Xtrans™ pattern from FUJIFILM (disclosed in document WO2023275032A1).

Document EP4390343 A1 discloses a polarimetric image sensor formed in and on a semiconductor substrate, the sensor comprising a plurality of pixels each comprising a photodetector formed in the semiconductor substrate, as well as a polarizing filter disposed on the illumination side of the photodetectors and comprising, for each pixel, a polarization structure, and finally a polarization router comprising a two-dimensional metasurface disposed on the side of the polarizing filter opposite the photodetectors, the metasurface comprising a two-dimensional array of pads. In this document, a decomposition of elementary light routing patterns into smaller elements, namely the optical output areas of each elementary pattern, is considered. This decomposition is based on intrinsic axes of symmetry of the arrangement of the pads of the corresponding metasurface, which are nanostructured pillars.

### SUMMARY OF THE INVENTION

The invention aims to reduce mutual coupling problems in a two-dimensional (2D) array of photodetectors (or pixels) associated with a polarization and/or wavelength optical router, for the detection of polarized and/or polychromatic light, respectively, in order to improve the sensitivity of the optoelectronic detector incorporating this pixel array.

The idea behind the invention is to specify the relative arrangement of base routers that are spatially repeated to cover the sensitive surface of the optoelectronic detector, in order to reduce the effect of mutual coupling (“Crosstalk”) within the photodetector array and thus improve routing efficiency. This efficiency can be reflected by the extinction ratio (or PER, which stands for “Polarization Extinction Ratio”). This idea can be exploited in the context of optical routing in light polarization, but not only. It can also be exploited in the context of optical routing in light wavelength. In particular, elementary mirror routers are available to place side by side (i.e., adjacent and contiguous) the pixels of two adjacent patterns that are dedicated to detecting light with a given polarization state or wavelength. This idea is specific to optical routing technology, for example in polarization and/or wavelength of light. There are no known studies on an ideal arrangement of polarization optical routers or wavelength optical routers on the surface of an optoelectronic detector such as a CMOS sensor.

A first aspect of the invention relates to an optoelectronic detector, comprising:
a matrix of elementary photodetectors or pixels arranged in rows extending in a first direction and in columns extending in a second direction, different from said first direction, said first direction and second direction defining the plane of a surface of the optoelectronic detector that is sensitive to incident light,
a device of pixel-level polarization or wavelength routing of the incident light, which is formed above the array of photodetectors,
   wherein:
the optical light routing device comprises one or more basic routers, each having an identical basic routing pattern,
   the basic router(s) being arranged above the photodetector array, as the case may be in such a way that the basic routing pattern is repeated spatially in the first direction and/or in the second direction to cover all or part of said array, and
   the basic routing pattern being symmetrical in the first direction and/or in the second direction,
each basic router comprises at least two elementary routers, each having an optical input zone and several optical output zones,
   the elementary routers being adjacent two-by-two along the first direction and/or along the second direction, and
   the elementary routers each having an identical elementary routing pattern of format N×M, where N and M are integers greater than one, at least one of which is strictly greater than one, said numbers N and M denoting the number of optical output zones of the elementary router that are adjacent to each other two-by-two, as the case may be, in the first direction and in the second direction, respectively,
each elementary router is adapted to sort at its output by optical routing, i.e., by selectively diverting the light received at the optical input area of said elementary router to one of the optical output areas of said elementary router as a function of its polarization or wavelength, the optical output areas of said elementary router each being operatively coupled to a respective associated pixel of the underlying photodetector array which is dedicated, alone or with other similar pixels, to detecting an incident light flux with a determined polarization or at a determined wavelength,
at least two elementary routers that are adjacent in the first direction or in the second direction within a basic router are arranged such that their respective elementary routing patterns are mirrored with respect to each other in said direction, so that one or more pixels associated with output areas of one of said elementary routers and one or more pixels associated with output areas of the other of said elementary routers, which are dedicated to detecting incident light flux with the same polarization state or at the same wavelength, are contiguous along said direction.

Thus, even in the case of mutual coupling between pixels within the photodetector array, some of the light with a specific polarization or wavelength (depending on the type of optical router) that is deflected beyond the pixel dedicated to detecting this optical characteristic of the incident light will still fall into an adjacent pixel that is also dedicated to this detection. The PER will be less degraded, while benefiting from the better sensitivity of the detector offered by optical routing compared to optical filtering. This result is achieved for pixels associated with optical output areas within the basic pattern that are formed side by side, given the mirroring of at least two elementary patterns that compose it. However, this effect is also obtained for pixels associated with optical output areas at the periphery of two adjacent basic routers when basic routers that are spatially repeated in the optical routing device are formed side by side and without spacing (i.e., they are repeated contiguously two by two), in the first direction or in the second direction, due to the symmetry of the basic pattern in one and/or both of these directions.

This arrangement of elementary polarization or wavelength-based optical routers provides a solution to the technical problem of cross-coupling between adjacent pixels, which is specific to the light routing function assigned to elementary routers aligned along the routing direction. This means that an identical or comparable arrangement, i.e., with mirroring of adjacent optical elements, may already have been considered (or could be considered) for other reasons and/or in other applications; but that, in the specific context of the application to polarization or wavelength optical routers in a direction of routing that corresponds to the direction of alignment of the elementary routers, this mirroring produces a technical effect that is specific to the solution to the technical problem of reducing the disadvantages of reciprocal optical coupling between adjacent pixels while benefiting from the better sensitivity of the optoelectronic detector offered by optical routing compared to optical filtering, as explained in the introduction.

In one embodiment, the optical light routing device can be a polarization-based optical routing device, wherein:
an elementary router comprises one or more binary routers each having two respective optical output zones (among the optical output areas of said elementary router, in the example),
   the two optical output zones of the binary router being adjacent in the first direction or in the second direction, and
   the binary router having a binary routing pattern of format 2×1 or 1×2, respectively,
each binary router is adapted to sort at its output by optical routing, i.e., by selective optical deflection toward one of the two optical output zones of said binary router, the incident light received at the optical input zone of the elementary router as a function of its polarization among two respective crossed polarization states.

In one embodiment:
at least one binary router of the elementary router can be designed to sort the incident light received at the optical input area of said elementary router by optical routing as a function of the polarization of said light among pairs of linear polarization states that are orthogonal to each other, for example, linear polarizations at 0° and 90°, respectively, or linear polarizations at 45° and 135°, respectively.

In one embodiment:
the elementary routing pattern of a given elementary router can be a 2×2 routing pattern with four optical output zones,
   said elementary router comprising two binary routers (for example, binary routers with an elementary routing pattern, each with two optical output zones, in 2×1 or 1×2 format, in the example),
   said binary routers each being designed to sort the incident light received at the optical input zone of the elementary router by optical routing as a function of the polarization of said light among respective pairs of linear polarization states that are orthogonal to each other, namely, for example, linear polarizations at 0° and 90° for one of said binary routers, and linear polarizations at 45° and 135° for the other of said binary routers.

In one embodiment:
the basic routing pattern of the basic router can be a 4×2 routing pattern comprising eight optical output zones,
   said basic router comprising two elementary routers with an elementary routing pattern of 2×2 format, each comprising two binary routers with a binary routing pattern of 2×1 format or 1×2 format, which are adjacent in the first direction or in the second direction, respectively,
   said elementary routers being adjacent in the first direction or in the second direction within the basic router and arranged such that their respective elementary routing patterns are mirrored with respect to each other in said direction, so that one or more pixels associated with output areas of one of said elementary routers and one or more pixels associated with output areas of the other of said elementary routers, which are dedicated to detecting light flux with the same linear polarization state, are contiguous along said direction.

In one embodiment:
at least one binary router of an elementary router can be adapted to sort the incident light received at the optical input area of said elementary router by optical routing as a function of the polarization of said light among the left circular and right circular polarization states (i.e., between left circular polarization and right circular polarization, in the example).

In one embodiment:
the basic routing pattern of a basic router can be a 3×2 or 2×3 routing pattern with six optical output zones,
   said elementary router comprising three binary routers (for example, binary routers with a routing pattern of 2×1 or 1×2 format, each with two output zones),
   said binary routers each being adapted to sort the incident light received at the input zone of said binary router by optical routing as a function of the polarization of said light among respective pairs of orthogonal polarization states, namely the orthogonal linear polarization states at 0° and 90° for a first of said binary routers, the orthogonal linear polarization states at 45° and 135° for a second of said binary routers, and the left circular and right circular polarization states for a third of said binary routers.

In one embodiment:
the basic routing pattern of a basic router can be a 4×3 or 3×4 routing pattern comprising twelve optical output zones,
   said unitary router comprising two elementary routers with a 2×3 or 3×2 routing pattern, each comprising three binary routers with a 2×1 or 1×2 routing pattern,
   said elementary routers being adjacent in the first direction or in the second direction within the basic router and arranged such that their respective elementary routing patterns are mirrored with respect to each other in said direction, so that one or more pixels associated with optical output areas of one of said elementary routers and one or more pixels associated with optical output areas of the other of said elementary routers, which are dedicated to detecting incident light flux with the same polarization state, are contiguous along said direction.

In one embodiment:
the basic routing pattern of a basic router can be a 4×6 format routing pattern comprising twenty-four optical output zones,
   said basic router comprising four elementary routers with a routing pattern of 2×3 or 3×2 format, each comprising three binary routers with an elementary routing pattern of 2×1 or 1×2 format,
   said basic router comprising four elementary routers with a routing pattern of 2×3 or 3×2 format, each comprising three binary routers with an elementary routing pattern of 2×1 or 1×2 format.

In one embodiment, the optical light routing device can be a wavelength light routing device, wherein:
the basic routing pattern of a basic router is a routing pattern comprising at least two optical output zones, each of which is associated with a specific wavelength, for example one of the wavelengths corresponding to the colors red, green, and blue, respectively.

In one embodiment:
the basic routing pattern of a basic router can be a 2×2 routing pattern comprising four optical output areas, of which:
   one optical output area is operatively coupled to a pixel of the underlying photodetector array that is dedicated to detecting light at the wavelength corresponding to the red color, and
   two other optical output areas that are diametrically opposed to each other and are respectively operatively coupled to two pixels of the underlying photodetector array that are dedicated to detecting light at the wavelength corresponding to the color green,
   the other optical output zone is operatively coupled to a pixel of the underlying photodetector array that is dedicated to detecting light at the wavelength corresponding to the blue color.

In one embodiment:
the basic routing pattern of a basic router can be a 4×4 format routing pattern comprising sixteen optical output zones,
   said basic router comprising four elementary routers, each with a 2×2 routing pattern, which are adjacent in pairs in the first direction and in the second direction within the basic router and arranged such that their respective elementary routing patterns are arranged in pairs mirroring each other along said first direction and along said second direction.

In one embodiment, the polarization or wavelength optical routing device can be formed from an optical routing meta-structure designed to sort the output of elementary routers by optical routing, i.e., to selectively deflect the incident light received at the input of the meta-structure to one or the other of the optical output areas of said elementary routers, as a function of its polarization state or wavelength.

In one embodiment, basic routers repeated in the optical routing device are formed side-by-side and without spacing, along the first direction or along the second direction.

In a second aspect, the invention also relates to a CMOS image sensor comprising an optoelectronic detector according to the first aspect above.

### BRIEF DESCRIPTION OF THE DRAWINGS

Other features and advantages of the invention will become apparent from the following description. This description is purely illustrative and should be read in conjunction with the accompanying drawings.

FIG. 1 is a schematic representation of a monochromatic light wave, following the model known as the “vibrating electrostatic dipole.”.

FIG. 2 is a simplified vertical cross-section diagram of an optoelectronic detector comprising a selective optical routing nanostructure of the metasurface type.

FIG. 3A is a schematic representation, viewed from above, of an elementary polarization-based light routing pattern in a 2×1 format (in other words, a binary elementary pattern) that can be formed by a nanostructure such as that shown in FIG. 2.

FIG. 3B is a simplified schematic representation, in vertical cross-section, of an optoelectronic light polarization detector using a binary optical router having the elementary binary routing pattern of FIG. 3A, and which is arranged directly above two associated pixels of an underlying matrix of pixels of the optical detector.

FIG. 3C is a schematic representation, viewed from above, of a polarization-based light routing device comprising an arrangement formed by the spatial repetition of the elementary binary routing pattern of FIG. 3A in a predetermined routing direction, without the implementation of the invention.

FIG. 3D is a schematic representation, viewed from above, of a polarization-based light routing device comprising an arrangement formed by the spatial repetition of the binary elementary routing pattern of FIG. 3A in the same routing direction as in FIG. 3B, but with adjacent elementary patterns mirrored in pairs along said routing direction, in accordance with the implementation of the invention.

FIG. 4A is a simplified vertical cross-sectional diagram of an optoelectronic detector comprising the polarization-based light routing device of FIG. 3C.

FIG. 4B is a simplified vertical cross-sectional diagram of an optoelectronic detector comprising the polarization-based light routing device of FIG. 3D.

FIG. 5A is a phase diagram illustrating the phase evolution of the electrical components polarized at 0° and 90° of the light in the direction of the polarization-based light routing in the optoelectronic detector of FIG. 3B.

FIG. 5B is a phase diagram illustrating the phase evolution of the electrical components of the light polarized at 0° and 90° in the direction of polarization-based light routing in the optoelectronic detector of FIG. 3C.

FIG. 5C is a phase diagram illustrating the phase evolution of the electrical components polarized at 0° and 90° of the light in the direction of polarization-based light routing in the optoelectronic detector in FIG. 3D.

FIG. 6A is a schematic representation, viewed from above, of an elementary 2×2 polarization-based light routing pattern (or quaternary elementary pattern), of a selective optical routing that can be achieved by a nanostructure such as that shown in FIG. 2.

FIG. 6B is a schematic representation, viewed from above, of a polarization-based light routing device comprising an arrangement formed by the spatial repetition of the 2×2 routing pattern of FIG. 6A in both a first predetermined direction X and a second predetermined direction Y perpendicular to each other, without the implementation of the invention.

FIG. 6C is a schematic representation, viewed from above, of a polarization-based light routing device comprising an arrangement formed by the spatial repetition of 2×2 routing patterns as in FIG. 3B, but with two adjacent elementary patterns mirrored in the X direction only, in accordance with embodiments of the invention.

FIG. 6D is a schematic representation, viewed from above, of a polarization-based light routing device comprising an arrangement formed by the spatial repetition of elementary 2×2 routing patterns as in FIG. 6B and FIG. 6C, but with two adjacent elementary patterns mirrored both in the X direction and in the Y direction, in accordance with other embodiments of the invention.

FIG. 7A is a schematic representation, viewed from above, of an elementary polarization-based light routing pattern of a 2×3 format (or six-element pattern) of a selective optical routing device that can be implemented by a nanostructure such as that shown in FIG. 2.

FIG. 7B is a schematic representation, viewed from above, of a polarization-based light routing device comprising an arrangement formed by the spatial repetition of the 2×3 routing pattern of FIG. 7A both in the X direction and in the Y direction, without implementing the invention.

FIG. 7C is a schematic representation, viewed from above, of a polarization-based light routing device comprising an arrangement formed by the spatial repetition of 2×3 routing patterns as in FIG. 7B, but with two adjacent elementary patterns mirrored in the X direction only, in accordance with embodiments of the invention.

FIG. 7D is a schematic representation, viewed from above, of a polarization-based light routing device comprising an arrangement formed by the spatial repetition of 2×3 routing patterns as in FIG. 7C, but with two adjacent elementary patterns mirrored both in the X direction and in the Y direction, in accordance with other embodiments of the invention.

FIG. 8A is a schematic representation, viewed from above, of a polarization-based light routing pattern of a 2×2 format of an optical routing device based on three respective wavelengths that can be formed by a nanostructure comprising a metasurface similar to that of FIG. 2.

FIG. 8B is a schematic representation, viewed from above, of a wavelength-based light routing device comprising an arrangement formed by the spatial repetition of the 2×2 routing pattern of FIG. 8A in both the X direction and the Y direction, without implementing the invention.

FIG. 8C is a schematic representation, viewed from above, of a wavelength-based light routing device comprising an arrangement formed by the spatial repetition of 2×2 routing patterns as in FIG. 8B, but with two adjacent elementary patterns mirrored both in the X direction and in the Y direction, in accordance with embodiments of the invention.

FIG. 9A, FIG. 9B and FIG. 9C are schematic representations, viewed from above, of the wavelength-based light routing pattern of FIG. 8A illustrating wavelength-based light routing rules for three different wavelengths that are processed by the corresponding wavelength-based light router.

### DESCRIPTION OF EMBODIMENTS

In the following description of embodiments and in the accompanying drawings, the same or similar elements are designated by the same reference numerals.

Here and throughout the rest of this description, a direct three-dimensional orthogonal coordinate system (X, Y, Z) is defined, which is conventionally linked to the Earth's surface. In this coordinate system, the X and Y axes form a plane parallel to the plane of the sensitive surface of the optoelectronic detector when it is laid flat horizontally. In addition, the Z axis is oriented orthogonally to the plane of the sensitive surface of the optical detector and along the axis of gravity. In the following description, the terms “vertical” and “vertically” are understood to refer to an orientation substantially parallel to the Z axis, and the terms “horizontal” and “horizontally” are understood to refer to an orientation substantially parallel to the (X,Y) plane. Furthermore, the terms “upper” and “lower,” “top” and “bottom,” “above” and “below,” and all derived terms and expressions such as “up” and “down,” or ‘above’ and “below,” for example, are understood to refer to an increasing or decreasing position, respectively, of two elements relative to the base support of the photodetector in the +Z direction. The terms “lateral” and “laterally,” as well as the expressions ‘beside’ or “adjacent,” or the terms “contiguous” and expressions incorporating them, are understood to refer to the relative positioning of two elements along the X-axis and/or Y-axis of the horizontal plane (X,Y), unless specifically stated otherwise.

Light is a wave that propagates through space in a specific direction, which is chosen here to be the vertical Z direction pointing downwards in the attached drawings, i.e., it illuminates the surface of the photodetector in a substantially orthogonal manner and from top to bottom. This corresponds to a use case for an optoelectronic detector when it is placed flat on a table, for example, with its sensitive surface facing upwards. The direction of propagation Z is perpendicular to the wave plane. In the illustrations given here, this wave plane therefore corresponds to the horizontal plane (X,Y) of the sensitive surface of an optoelectronic detector. Optoelectronic detectors are sensitive to the time-averaged value of the square of the electric field: this is the light intensity.

An optoelectronic detector is typically a two-dimensional (2D) detector. As such, it comprises at least one matrix of photodetectors (or pixels) arranged in rows extending in a first direction and in columns extending in a second direction, different from said first direction. In the examples illustrated, these two directions are the X direction and the Y direction, respectively, which define the plane of the sensitive surface of the detector. It should be noted that the embodiments are not limited to 2D optical detectors, but are compatible with three-dimensional (3D) optical detectors comprising at least two photodetector arrays superimposed along the vertical Z direction.

Like any electromagnetic (EM) wave that propagates, light consists of an electric field E and a magnetic field B that are associated with each other, perpendicular to each other, and each orthogonal to the direction of propagation of the wave. Like all waves, a light wave can be analyzed using the mathematical methods and tools of spectral analysis: any light wave can be broken down into so-called “monochromatic” plane waves, i.e., waves each with a pure frequency (i.e., a single wavelength).

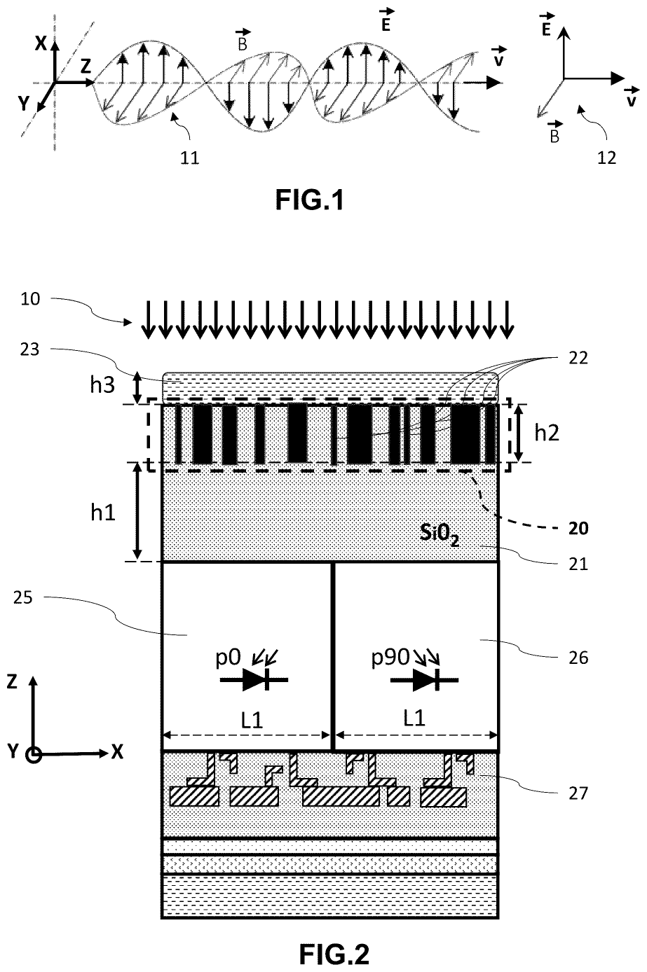

With reference to the diagram in FIG. 1, a monochromatic electromagnetic wave 11 can be modeled by a vibrating electrostatic dipole 12. The figure illustrates the coupled oscillation of the electric field E and magnetic field \vec{B} of such a wave, following the model of the dipole vibrating along the direction of propagation \vec{v} (the trihedron {\vec{E}, \vec{B}, \vec{v}} being a direct dihedron). The variations in the electric and magnetic fields are linked by Maxwell's equations. The wave can therefore be represented and studied using only one of these two fields. It is often decided, by convention, to ignore the magnetic field, as it can be determined from the electric field. We will therefore only consider the electric field \vec{E} perpendicular to the direction of propagation Z.

In a homogeneous and isotropic medium, all electromagnetic waves propagate in a straight line. When they encounter an obstacle, diffraction occurs. When there is a change in medium, reflection and refraction occur. Refraction also occurs if the properties of the medium change depending on the location (i.e., in the case of heterogeneity of the propagation medium): light is deflected when it passes from one medium to another, as these respective media have different phase velocities in chemical or physical terms (density, impedance, etc.).

For the study of phenomena related to optical propagation such as those mentioned above, the concept of electromagnetic waves complements that of photons: this is the wave-particle duality of light. In fact, the wave approach provides a more relevant description of radiation for low frequencies (i.e., long wavelengths) such as radio waves. But in reality, the electromagnetic wave represents two distinct concepts at the same time, namely:
the macroscopic variation of the electric field \vec{E} and magnetic field \vec{B} presented above, which is treated according to a wave approach; and,
the wave function of the photon, i.e., the square of the wave's norm, which is the probability of a photon's presence, and which is treated according to a corpuscular approach.

In the field of optics, where light corresponds to electromagnetic wave radiation at frequencies higher than radio frequencies, when the energy flux is greater than the individual energy of the photons, we can consider that we have a quasi-continuous flux of photons, and the two concepts above overlap. However, this is no longer true when the energy flux of the radiation is low (for example, in applications where photons are sent one by one). In this case, the concept of macroscopic (average) variation in photon flux no longer makes sense. The wave approach to studying propagation-related phenomena is then discarded in favor of the particle approach, which draws on the rules of quantum physics.

Furthermore, light polarization is a property of vector waves (i.e., waves that can oscillate in more than one direction) that exhibit a preferred distribution of the orientation of their constituent vibrations. Thus, light, like all electromagnetic waves, has polarization properties. The polarization of an EM wave is determined by the behavior of its electric field \vec{E} over time. More specifically, wave polarization is characterized by the trajectory of the end of the wave's electric field \vec{E} in the wave plane. In other words, polarization corresponds to the direction and amplitude of the electric field \vec{E}. For an unpolarized wave, or natural wave, the field \vec{E} rotates around its axis in a random and unpredictable manner over time. A polarized wave corresponds to a wave with a defined trajectory of the electric field. There are three types of polarization:
linear polarization: the electric field \vec{E} is always oriented in the same direction;
circular polarization: the electric field \vec{E} has a constant amplitude and rotates around its axis, forming a circle; and
elliptical polarization: the electric field \vec{E} rotates around its axis and changes amplitude to form an ellipse.

Classically, wave phenomena of light are described with reference to curves that give a spatial representation, instantaneous at a fixed time, of the positions of the arrowhead of the vector representing the electric field \vec{E} in all wave planes superimposed vertically along the direction of propagation Z. These curves are constructed by transferring the field vector that existed in the wave plane at a past instant to the vertical distance (so that the effect of propagation is taken into account):
the curve representing linear polarization is a sine wave plotted on the vertical plane;
the curve representing circular polarization is a helix wound around a vertical cylinder, the base of which is a circle; and,
the curve representing elliptical polarization is a helix-like curve drawn on a flattened vertical cylinder, the base of which is an ellipse.

Considering the two vector components \vec{E_{X}} and \vec{E_{Y}} which define the orientation of the electric field \vec{E} in the (X,Y) wave plane, the figure described over time by the electric field \vec{E} at a given point can then be:
a straight line segment, for example in the case of linear polarization, which is illustrated in FIG. 1;
a circle, in the case of circular polarization; or,
an ellipse, in that of elliptical polarization.

In short, in an electromagnetic (EM) wave, the electric field \vec{E} and the magneticic field \vec{B} oscillate simultaneously in directions perpendicular to each other. By convention, the polarization of light describes the vibration of the electric field \vec{E}. The wave is linearly polarized when it has only one component \vec{E_{X}} or \vec{E_{Y}} that is, the electric field \vec{E} oscillates in only one of the X and Y directions. When a wave consists of two components \vec{E_{X}} and \vec{E_{Y}} polarized at 90° to each other and these two components are also out of phase by 90° relative to each other, then its polarization appears to rotate around the direction of propagation of the wave. In this case, it is referred to as elliptical polarization, or circular polarization when the two components also have the same intensity. The direction of rotation, clockwise or counterclockwise, depends on the phase shift between the two components, which also depends on the properties and optical activity of the media traversed. Circular and linear polarization are special cases of elliptical polarization: in the first case, both components \vec{E_{X}} and \vec{E_{Y}} are of equal amplitude, and in the second case one of the components \vec{E_{X}} and \vec{E_{Y}} is null. Furthermore, an elliptically polarized wave can be viewed as the sum of circular polarization and linear polarization.

In the implementation examples given here, the optical detector is an optoelectronic sensor in which the separation of the polarization states of the captured light takes place directly at the sensitive surface of the optoelectronic sensor, at the level of the elementary photodetector or pixel. This may be, without limitation, an image sensor using CMOS technology, for example. Alternatively, it may also be an image sensor of the charge-coupled device (CCD) type. Other applications may be envisaged in photonic devices with optical fibers or optical waveguides.

The following is a presentation of the polarization-based or wavelength-based light routing device. This device performs a spatial deflection of the light wave (photons) based on the polarization or wavelength of the incident light. It allows the distribution of light illumination of pixels to be modified, as the light is selectively routed, i.e., preferentially deflected toward certain pixels depending on its polarization or wavelength, as it passes through the optical routing device.

The embodiments that will now be described may use metasurface technology to implement the proposed optical routing device. Metasurfaces are functional photonic components capable of manipulating all properties of light, i.e., not only amplitude and/or wavelength, but also phase and/or polarization. Other implementation technologies could potentially be considered, including technologies known in the field of microelectronics and nanotechnology in general, and nano-photonics in particular, but these are not considered here.

FIG. 2 shows a simplified cross-sectional view of a metasurface (MS) integrated into an optoelectronic detector. With reference to the figure, the metasurface 20 is made up of an array of scattering elements, i.e., nanoscale atomic structures (or meta-atoms) that scatter light. These elements take the form of nanostructured pillar 22 (also referred to as nanopillars). They have sizes and spatial distribution periodicities on the surface that are smaller than the wavelength of the light in question (referred to as “subwavelength” size). A metasurface is therefore a tiling of optically active elements with a high diffraction index (i.e., nanopillars) and elements with a low diffraction index (i.e., the spaces between the nanopillars, or spatial interstices), which are made of a different interstitial material.

In the context of manufacturing polarization-based or wavelength-based optical routers, the geometric parameters and periodic arrangements of the nanopillars make it possible to control the phase, or wavefront, of an incident light beam. Thus, a metasurface is specially designed to provide a phase, i.e., a wavefront, via the placement and variation of the size of the nanopillars 22. The phase characteristics are determined in advance, according to the optical routing function to be obtained, for the optical characteristic of the light in question (e.g., wavelength and/or polarization). A metasurface is manufactured using nanomanufacturing processes, including a step of etching nanostructures onto a substrate. A description of these processes would be beyond the scope of this description.

With reference to FIG. 2, the nanopillars 22 are formed above or in the upper part of a support called the pedestal 21 (or “spacer”), whose thickness h1 in the Z direction is a few micrometers (μm) or microns. The pedestal 21 is formed above photodetectors (pixels) 25 and 26. These photodetectors may be, for example, photodiodes conventionally made using CMOS technology. The dimension of pixels 25 and 26 in the X direction, or length L1, may be a few microns (μm). The nanopillars 22 are covered with one or more additional layers 23, for example at least one layer of anti-reflective material and at least one passivation layer. The total thickness h3 of this complex of upper layers, considered in the Z direction, may be a few hundred nanometers (nm). In view of their main physical properties, these layers can be collectively referred to as “anti-reflective,” which is more or less a misnomer but reflects a certain functional reality.

The nanopillars 22 themselves have a height h2 in the Z direction, which can be between approximately 100 nm and approximately 1500 nm, or even more, depending on the requirements of the application in question. The material from which the nanopillars 22 are made also depends on the requirements and the wavelength of the light 10 in question. Thus, for example:
for light in the near-infrared spectrum (known as the “near-IR” spectrum), these are generally nanoparticles of amorphous silicon (Si);
for light in the visible spectrum, they may include, but are not limited to, silicon nitride (SiN), titanium dioxide (TiO2), aluminum oxide or alumina (Al2O3), etc.

In the jargon of the skilled person, what is generally meant by “meta-surface” is limited to the nanostructure 20 formed by the arrangement of the nanopillars 22 and the material that encompasses said pillars in the horizontal plane that contains them but excludes the pedestal 21 above which the nanopillars 22 are made. This is even though said pedestal may possibly be made of the same material as the interstitial material present between said pillars 22, for example silicon dioxide (SiO2). The pedestal may also be made of material different from said interstitial material, depending on the specific requirements of each application and the manufacturing processes used. This can be any semiconductor or dielectric material whose properties meet the requirements, generally including a refractive index of interest, ease of deposition during the manufacturing phase, and/or transparency (i.e., zero absorption) at the working wavelength. Similarly, the layer, or rather the stack of layers 23 that is formed above the nanopillars 22, is generally excluded from the definition of a metasurface according to the currently most widely accepted meaning of the term.

An interconnection structure 27 located beneath pixels 25 and 26 comprises the metallization of the pixel readout circuit. These metallizations are generally made of metal, such as copper (Cu) or aluminum (Al). They comprise horizontal metal lines formed in metallization levels stacked in the vertical Z direction, which are insulated from each other by interlayer dielectric (electrical insulator) material. Generally, the dielectric material is silicon dioxide (SiO2), but it can be any other oxide or even another type of dielectric material, such as a nitride, for example. The metallization also includes vertical connections (or “vias”) that electrically connect the horizontal metallization to each other and to the active circuits in the lower layers (not detailed here). These vertical metallization lines pass through one or more layers of dielectric material.

It will be noted that one of the causes of mutual coupling between adjacent pixels in an optoelectronic detector lies in the fact that incident light not absorbed by the photodiodes of pixels 25 and 26 is reflected by metal lines of the interconnection structure 27 and travels upward, then is partially reflected again in the adjacent pixels by the upper layers. This reflected light “pollutes” the effect of the incident light, reducing the rejection rate offered by the desired light routing.

A light router or optical router is an optical device with an optical input and at least two optical outputs, designed to sort the light received at the input depending on a parameter of the incident light, such as its polarization state (i.e., its polarization) or its wavelength (i.e., its “color”). The light is not intentionally filtered, i.e., most of the light intensity received at the input is transmitted at the output through the optical router. The light is simply sorted, i.e., it is intentionally deflected, selectively, with part of the incident light flux being transmitted preferentially to one optical output while another part of said flux is transmitted preferentially to the other optical output (or to one of the other optical outputs of the router, as the case may be), depending on the polarization or wavelength of the light.

In the embodiments, this optical device is used in combination with independent photodetectors or pixels, namely at least two pixels that are independent of each other and respectively associated with each of the two optical output areas of the router (more generally, one pixel is associated with each optical output area of the router). Arranged in this way, each pixel can detect light with one polarization or the other (or one of the other polarizations, as the case may be), or light at a specific wavelength or another wavelength (or one of the other wavelengths, as the case may be). Of course, part of the incident flux may be transmitted through the router without actually being routed to the intended pixel, or even without being routed at all, i.e., without any particular deviation, either because of inherent imperfections in the router or because that part of the incident flux does not meet any of the routing criteria defined by the router's design. This will be the case, for example, with a router designed to sort a few specific wavelengths in an incident light flux whose frequential content is broader, i.e., which contains wavelengths other than those that the router is designed to separate.

The person skilled in the art will appreciate from the example in FIG. 2 that the optical input of the optical router, which in this example is defined by meta-structure 20 in the optoelectronic detector shown, is defined by its upper surface. In other words, this upper surface constitutes its optical input area, in the sense that incident light enters the optical router via this surface. On the other hand, its various optical outputs are defined by respective portions or areas of its lower surface, each of which is aligned with one of the associated photodetectors (pixels) 25 and 26. Advantageously, when the optical router is used in an optoelectronic detector, the optical output areas of the optical router are preferably directly above their respective associated pixels, i.e., in direct optical coupling with the active part of said pixels. By “direct optical coupling” it is meant that the optical coupling of the output areas of the router with the associated underlying pixels is achieved without the interposition of an intermediate element such as a lens or other similar optical element. It is therefore for convenience and somewhat of a misnomer that it is sometimes referred to as separate “light flows” at the router output, as there are not strictly speaking any separate light flows being created, the light sorted by the optical router being immediately converted into separate electrical signals by the underlying pixels. Of course, this observation does not prevent other structures from being “stacked” in certain applications to perform other optical functions in addition to the optical routing of light. For example, a router and microlenses can be stacked to improve angle performance, and/or a filter can be stacked to refine the router's response.

In the example illustrated schematically in FIG. 2, the metasurface 22 formed above pixels 25 and 26 is designed to route (i.e., deflect) incident light, depending on its polarization, either into pixel 25 or into the other pixel 26. The two polarizations considered are, for example, orthogonal linear polarizations. More specifically, in the example shown in FIG. 2, the 0° linear polarization is routed into the left pixel 25 (the one shown on the left of the figure), while the 90° linear polarization is routed into the right pixel 26 (the one shown on the right of the figure).

The polarization extinction ratio (PER) is defined, on a per pixel basis, as the ratio between the amount of light captured with the desired polarization and the amount of light captured with the undesired polarization. The PER of the left pixel 25 is therefore the quantum efficiency (QE) of the left pixel illuminated by light polarized at 0°, divided by the QE of the left pixel 25 illuminated by light polarized at 90°. The same procedure is used to determine the PER of the right pixel 26. It should be noted that, for a photodetector (pixel), the QE reflects the efficiency of the light/electric charge conversion, given by the number of electrons produced in the photodetector relative to the number of photons in the incident light flux. It should be noted that, in the ideal case of a perfect optical routing, the PER of each of the pixels 25 and 26 would be infinite.

The person skilled in the art will also appreciate that the composition of the metasurfaces forming the light routers depends on the specificities of each application, in particular the desired optical routing criterion, the pixel size, the operating wavelength(s), the incidence of the input light, its polarization, etc. Describing the detailed implementation of a routing nanostructure based on these different characteristics is not useful and would go beyond the scope of this disclosure.

It will now be defined several levels of optical routing units, both for lexicographical purposes and from a functional point of view, to explain the technical effects that form the basis of the invention and which will be developed further below.

The most elementary optical routing unit, i.e., a minimalist optical router with one optical input area and only two optical output areas for sorting incident light as a function of two distinct values of a given optical characteristic, is referred to below as a “binary router.” This is an elementary optical router that is designed to sort the incident light received at the optical input area on the basis of its polarization among two given polarization states or on the basis of its wavelength among two determined wavelengths, in combination with the two associated pixels that are arranged below the two output areas of the binary router.

Furthermore, the term “binary routing pattern” refers to the spatial configuration, as seen in the plane of the sensitive surface of the optoelectronic detector, which is parallel to the horizontal plane (X,Y) in the examples shown in the figures, of the two optical output areas of the binary optical router. This spatial configuration is adapted to separate the light output from the binary router into two distinct pseudo “sub-fluxes” (or “sub-flow” or “sub-stream”) of light, by discriminating between distinct respective values of one of the optical parameters, i.e., polarization or wavelength in the examples considered here, of the incident light that is received on the input area. The skilled person will appreciate that this is also, and correlatively, the spatial configuration of their two associated pixels in the underlying photodetector array, namely associated pixels 25 and 26 in the example shown in FIG. 2.

The direction in which the two optical output areas of the elementary router are arranged side by side (they can be said to be “aligned” in said direction), and consequently the direction in which the two pixels respectively associated with them in the photodetector array are aligned, is called the routing direction. It is in fact in this direction that part of the incident light is spatially deflected by the optical router, depending on its polarization state or wavelength. In the embodiments given in this description with reference to the figures in the drawings, this direction is the X direction or the Y direction, which define the plane of the photosensitive array of the optoelectronic detector.

In what follows, the notation 1×2 and the notation 2×1 refer to what is called the “format” of the binary optical router, or the “format” of the routing pattern of said optical router. The first digit refers to the number of optical output areas of the binary optical router present in the first X direction of the photodetector matrix or array (direction of the rows of the array). The second digit refers to the number of optical output areas of the binary optical router present in the second Y direction of the photodetector matrix (direction of the columns of the array). Thus, a 1×2 binary optical router is a binary optical router whose routing pattern comprises two optical output areas arranged in a column, i.e., aligned along the Y direction. Conversely, a 2×1 binary optical router is a binary optical router whose routing pattern comprises two optical output areas arranged in a line, i.e., aligned along the X direction.

When the optical routing device is a polarization-based light routing device, a binary optical router is generally adapted to sort at the output, by optical routing, i.e., by selective optical deflection to one of its two optical output areas, the light received at its optical input area as a function of its polarization among two respective crossed polarization states. For example, thanks to its two optical output areas, a binary optical router can be adapted to sort at the output, by optical routing, the incident light received at the optical input area depending on the polarization of said incident light among pairs of linear polarization states that are orthogonal to each other, for example, 0° and 90° polarizations, respectively, or the polarization states at 45° and 135°, respectively, or even between left circular polarization (or LC, for “Circular Left”) and right circular polarization (or RC, for “Circular Right”), respectively. Other pairs of linear polarization states that are orthogonal to each other may be considered depending on the requirements of each application, and the embodiments are not limited to the above examples.

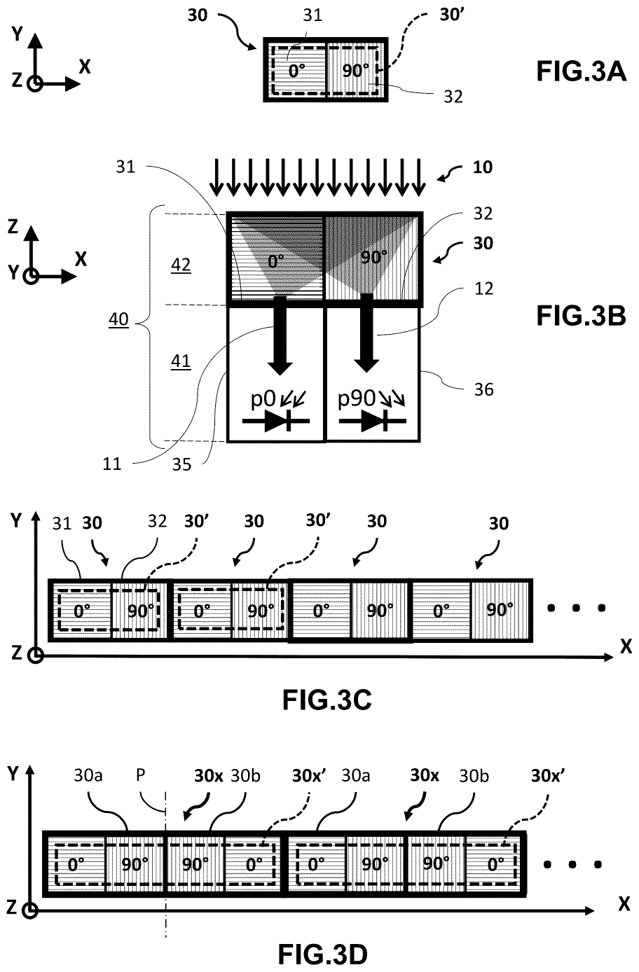

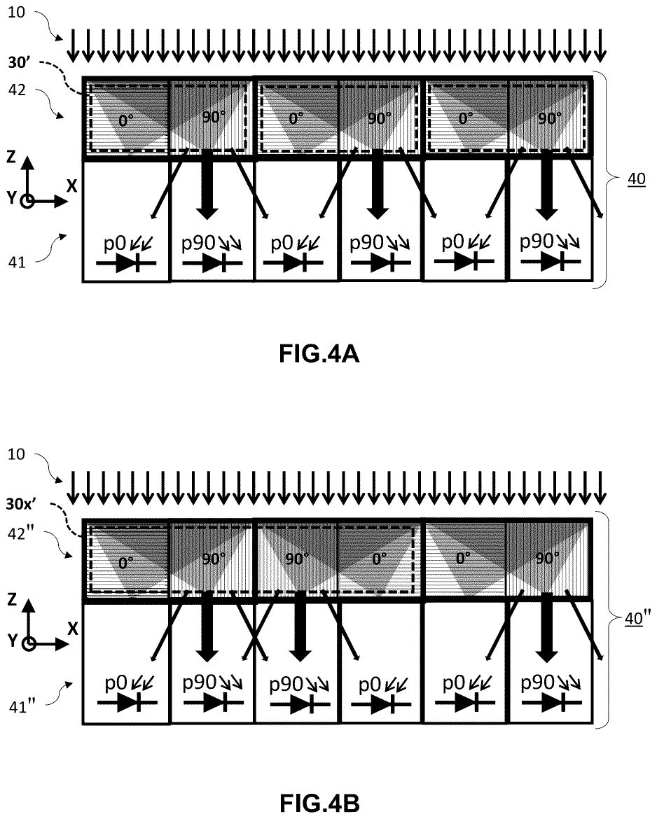

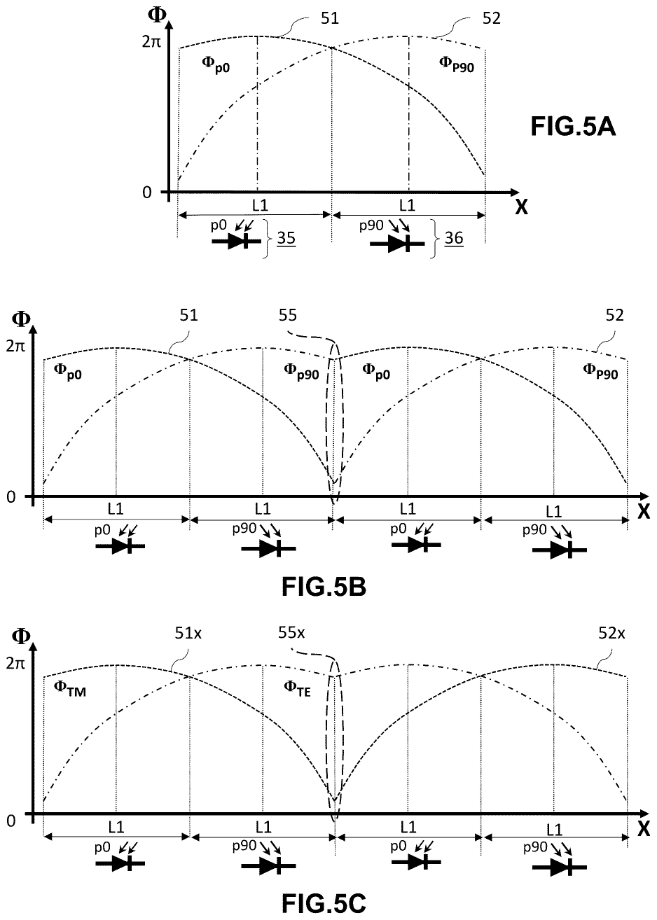

For clarity of the following description of non-limiting embodiments, it will be considered hereinafter, with reference to the diagrams in FIG. 3A to FIG. 3D, FIG. 4A to FIG. 4B, and FIG. 5A to FIG. 5C, the case of a binary optical router adapted to sort at the output the incident light received at the input as a function of its polarization between two crossed linear polarization states, which are 0° polarization and 90° polarization, respectively.

Depending on the application, it may be necessary to separate more than two polarization states of incident light, for example, among a plurality of pairs of crossed linear polarization states. These may be, for example, linear polarization states orthogonal at 0° and 90°, respectively, and linear polarization states orthogonal at 45° and 135°, respectively, and/or left circular polarization (LCP) and right circular polarization (RCP), respectively. In this case, the elementary optical router is an elementary optical routing cell larger than a binary optical router, i.e., larger than 1×2 or 2×1. For example, it comprises as many different binary optical routers as there are different pairs of crossed polarization states to be separated. For example, these different binary optical routers are arranged side by side, i.e., adjacent to each other in pairs, in the plane of the elementary optical router thus formed, parallel to the sensitive surface of the photodetector array, above said array.

By extension of the concept of “binary routing pattern” for a binary router introduced above, an “elementary routing pattern” refers to the spatial configuration, as seen in the plane of the sensitive surface of the optoelectronic detector, of the various pairs of optical output areas of the elementary router. Correlatively, it also refers to the spatial configuration of their associated underlying pixels within the 2D photodetector array. This spatial configuration makes it possible to generate distinct pairs of pseudo “sub-flows” of light at the output of the elementary router by discriminating, for each of these pairs, between two distinct polarization states that are present in the input light flow.

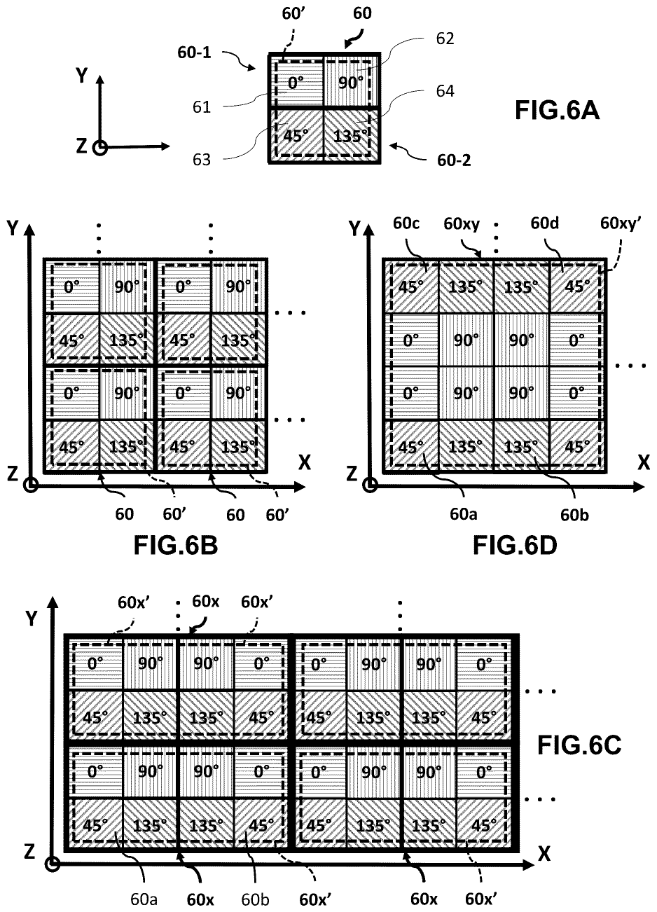

To illustrate these embodiments with a first example, it will be considered below, with reference to the diagrams in FIG. 6A to FIG. 6D, the non-limiting example of an elementary optical router adapted to sort the incident light at the output depending on its polarization among four linear polarization states that are orthogonal two-by-two, which are:
polarization at 0° and orthogonal polarization at 90°, on the one hand, and
45° polarization and 135° orthogonal polarization, on the other hand.

This elementary optical router has a 2×2 format and comprises two binary optical routers, each of which has a 2×1 format, said binary optical routers being aligned in a column in the Y direction.

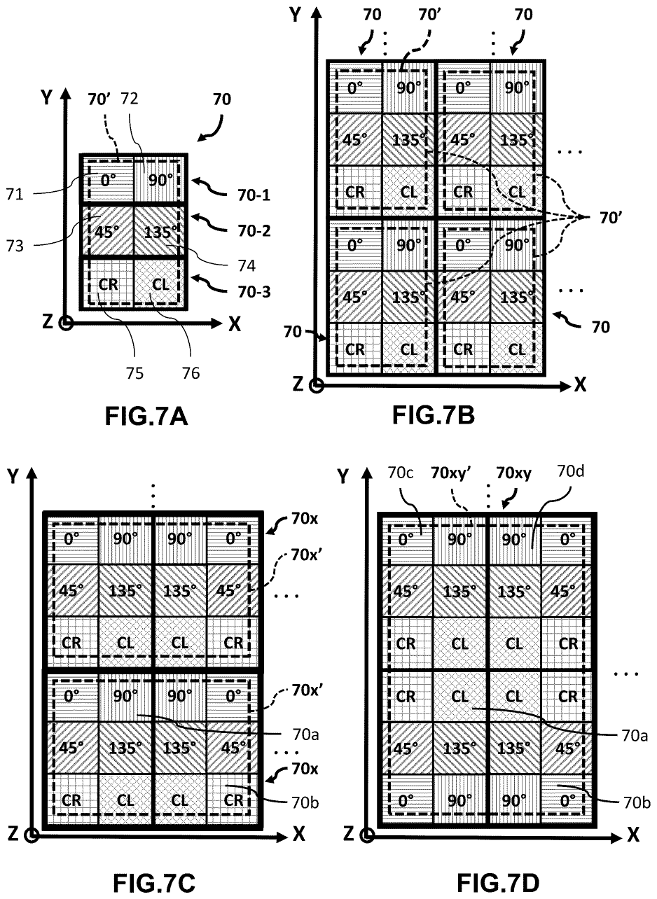

Next, and with reference to the diagrams in FIG. 7A to FIG. 7D, yet another example of a elementary optical router will be considered, which is adapted to sort the incident light received at the input depending on its polarization among six polarization states that are crossed two-by-two, which are:
linear polarization at 0° and orthogonal linear polarization at 90°,
linear polarization at 45° and orthogonal linear polarization at 135°, and finally,
left-hand circular polarization (LCP) and right-hand circular polarization (RCP).

This elementary optical router has a 2×3 format. It comprises three binary optical routers, each having a 2×1 format, said three binary optical routers being aligned in a column in the Y direction.

More generally, each elementary optical router has an N×M format, where N and M are integers greater than one (≥1) and at least one of which is strictly greater than one (>1). In the examples shown in the figures, N is the number of output areas of the unit routing pattern that are arranged side by side along the X direction, and this number is strictly greater than unity (N≥1), while M is the number of its output areas that are arranged side by side along the Y direction, and this number is greater than or equal to unity (M≥1). But the reverse is of course also possible, i.e., N can be greater than or equal to unity (N≥1), while M is strictly greater than unity (M>1).

In all cases, the N×M optical outputs of an elementary router comprise pairs of dual selective light routing output areas. For an optical light polarization router, these dual output areas are designed to separate at least two crossed polarization states from among pairs of crossed polarization states, i.e., pairs of crossed polarizations. In other words, each pair of crossed polarization states to be separated corresponds to a binary optical router having a pair of optical output areas coupled to respective pixels, each of which is dedicated to detecting one of these two polarization states.

For example, and preferably, binary optical routers that are different from an elementary optical router, each adapted to separate pairs of polarization states determined in the incident light, may be arranged adjacent to each other in pairs in a direction different from the optical routing direction as defined above, which is common to all binary optical routers. Thus, if the optical routing direction is the X direction, then the 2×1 binary optical routers of the N×M (with N>1) elementary optical router can be arranged adjacent to each other in pairs along the Y direction or, vice versa, if the routing direction is the Y direction, then the 1×2 binary optical routers of the N×M elementary optical router (with M>1) can be arranged adjacent to each other in pairs along the X direction.

In a variant, the binary optical routers of the elementary optical router may be arranged adjacent two-by-two along the direction of light routing within the binary routers. This alternative configuration is possible but is not ideal. Indeed, in accordance with the embodiments that will be explained further below with reference to examples, two elementary optical routers are arranged so as to be adjacent to each other in the direction of light routing, and mirrored with respect to each other in said direction, within a larger optical routing cell called a “basic optical router.” The technical effect sought by this particular arrangement of the two elementary routers, arranged head-to-tail in the routing direction within the basic router, may be less effective, or even completely ineffective, with the above variant.

In the optical light routing device, a “basic optical router” is the optical routing unit that is spatially repeated (or replicated) along the X-direction and/or along the Y-direction to cover all or part of the photodetector array (pixels). These basic routers are arranged above the photodetector array. They each have an identical basic routing pattern. In accordance with the embodiments, this basic routing pattern is symmetrical in the X direction and/or in the Y direction. To this end, it comprises two elementary optical routers adjacent in the X direction which are arranged mirrored to each other in said direction, and/or two elementary optical routers adjacent in the Y direction which are arranged mirrored to each other in said direction.

Furthermore, the term “basic routing pattern” refers to the spatial configuration (assessed in the plane of the sensitive surface of the optoelectronic detector, which is parallel to the horizontal plane (X,Y) in the examples shown in the figures) of the optical outputs of the basic router. The person skilled in the art will appreciate that, by extension of what has been said above about an elementary router and a binary router in particular, this also refers, correlatively, to the spatial configuration of their associated pixels in the underlying photodetector matrix. This spatial configuration is adapted to sort the light at the output of the basic router (this can be thought of as generating distinct pseudo “sub-fluxes” of light at the optical output areas of the router), by discriminating between distinct respective values of one of the optical parameters, i.e., polarization or wavelength in the examples considered here, of the light received at the input of the basic router.

A basic optical router is therefore an optical router with a basic routing pattern that is symmetrical along at least one of the X and Y directions, this symmetry resulting from the fact that said basic router comprises two elementary optical routers with an elementary N×M format pattern that are arranged contiguously in alignment along said direction (which is preferably the optical routing direction, i.e., the X direction in the drawings), and of which one is the image (or reflection) of the other by orthogonal symmetry with respect to a plane P of 3-dimensional Euclidean space that is orthogonal to said direction of alignment, called P-plane symmetry or reflection.

In mathematics, in 3-dimensional Euclidean affine space, a reflection is an orthogonal symmetry with respect to a plane orthogonal to an axis of observation. One element is the symmetrical image of another element when it is the image of that other element by a transformation that is a symmetry with respect to a plane P orthogonal to an axis joining the two elements. The origin of the term can be understood in relation to mirrors that reflect an image. Indeed, the first router and the second router are images of each other through a transformation that is a symmetry with respect to a plane P orthogonal to the X direction along which they are aligned. This is why it is also said that the second router is arranged “mirrored” to the first router along the X direction. An element is said to be symmetrical when it is the image of itself through a symmetry.

A unidirectionally symmetrized routing pattern is therefore a symmetrical pattern of format 2N×M or N×2M, which exhibits symmetry in a single direction determined among the X and Y directions due to the arrangement of two elementary routers mirroring each other along said direction. In the example shown in FIG. 4B, this single direction is the X direction, so that the router is symmetrical along the X axis. In what follows, it will be referred to as unidirectional symmetry along the X direction, which corresponds to the direction in which this symmetry is observed. The unidirectionally symmetrical routing pattern therefore has symmetry along the X direction, which is advantageously the direction of alignment of the routers. Similarly, a bidirectionally symmetrical routing pattern is a symmetrical pattern of format 2N×2M, which exhibits symmetry along both the X-direction and the Y-direction, due to the arrangement of pairs of elementary routers mirroring each other both along the X-direction and along the Y-direction.

In other words, and to summarize, a binary optical router is a router with two optical outputs, i.e., a pair of optical output areas, whereas an elementary optical router is a router with two or more optical outputs, i.e., an optical router with a group of Q output areas, where Q is an integer greater than 2. An elementary router can therefore be a binary router, in the specific case where Q is equal to 2 (Q=2). A plurality of sorting functions are simultaneously and jointly performed within a single elementary optical router combining several binary optical routers by routing the output light to generate pairs of separate pseudo light “sub-flows” that are respectively detected by distinct pairs of associated pixels. This plurality of sorting functions results from the plurality of pairs of polarization states that are discriminated, each by one of the different binary optical routers. Stated otherwise, an elementary router can be represented as a router having a single optical input defined by its upper surface, and one or more pairs of optical outputs which are the two respective optical outputs of as many distinct binary optical routers included, as the case may be, in said elementary optical router.

Furthermore, a basic optical router comprises two adjacent elementary routers, which are arranged mirrored to each other, along one and/or both of the X and Y directions that define the plane of the sensitive surface of the pixel matrix, and preferably along the direction of optical routing in particular. The basic pattern of a basic optical router is symmetrical along the direction of alignment of the two elementary routers of the corresponding basic router. Basic routers, which are all identical, are duplicated, being adjacent two-by-two, in the X direction and/or in the Y direction, to cover all or part of the sensitive surface of the optoelectronic detector. In this regard, it is referred to as the basic pattern of the basic routers being repeated spatially in the X direction and/or in the Y direction.

The skilled person will appreciate that the format of a basic router is preferably as regular as possible, i.e., N and M are numbers as close to each other as possible. The ideal case is that of a regular elementary router, for which Nis equal to M (N=M), the N×M format routing pattern being square. Elementary routers are designed to be spatially repeated in both the X and Y directions in order to cover the sensitive surface of the photodetector array. For reasons of uniformity in the distribution of the optical output zones of the optical routing device dedicated to detecting the different polarization states or wavelengths of the incident light, it is therefore preferable to avoid having an elementary optical router with a very irregular format (i.e., with N much greater than or much less than M).

In one example, the difference between N and M is at most equal to four (i.e., |N−M|≤4), preferably less than three (i.e., |N−M|≤3), and even more preferably less than or equal to two (i.e., |N−M|≤2).

With reference to the simplified diagram in FIG. 2 and, furthermore, in the case of the examples briefly introduced above and which will be explained in more detail below, only optical routing based on the polarization of light has been considered.

However, it is of course understood that a basic optical router, i.e., an optical router with one optical input and N×M optical outputs, can also be used when the optical routing device is an optical wavelength-based light routing device. For example, a binary wavelength optical router comprises two optical output areas at which the incident light received at the router input is sorted on the basis of two distinct wavelengths that are present, as the case may be, in said incident light. Use cases in which light is to be sorted based on only two wavelengths appear, at first sight, to be few in practice, but there is nothing to prevent the technical teaching disclosed in this description from being applied to binary optical routers intended for such use cases.

However, when one seeks to sort light in a photoelectronic device on the basis of wavelength, it is generally to separate the detection of the three colors traditionally considered in optoelectronics, namely red (R), green (G), and blue (B). This is why a basic wavelength optical router will generally be an optical router with one optical input and at least three optical outputs, each associated with a pixel in the photodetector array. Often, for reasons related to the topology of two-dimensional (2D) photodetection devices, the routing pattern of the basic wavelength-division optical router will be a 2×2 square pattern. Such an elementary optical router has one optical input and four optical outputs, each associated with a pixel in the underlying photodetector array, and two diametrically opposed optical output areas are dedicated to detecting the same color among red, green, and blue. In this way, one of the colors is used twice as much as each of the other two. This is reminiscent of the basic pattern of a color filter array (CFA) or Bayer matrix, which is a 2×2 RGB (red-green-blue) filter matrix applied to the photodetectors of a CMOS color sensor. In such a filter array, green is used twice as much as red and blue in order to bring the color sensor closer to the vision of the human eye, which sees better in green than in red or blue. But the similarity ends there, since both structurally and functionally, a Bayer pattern color filter has no relation to a wavelength optical router.

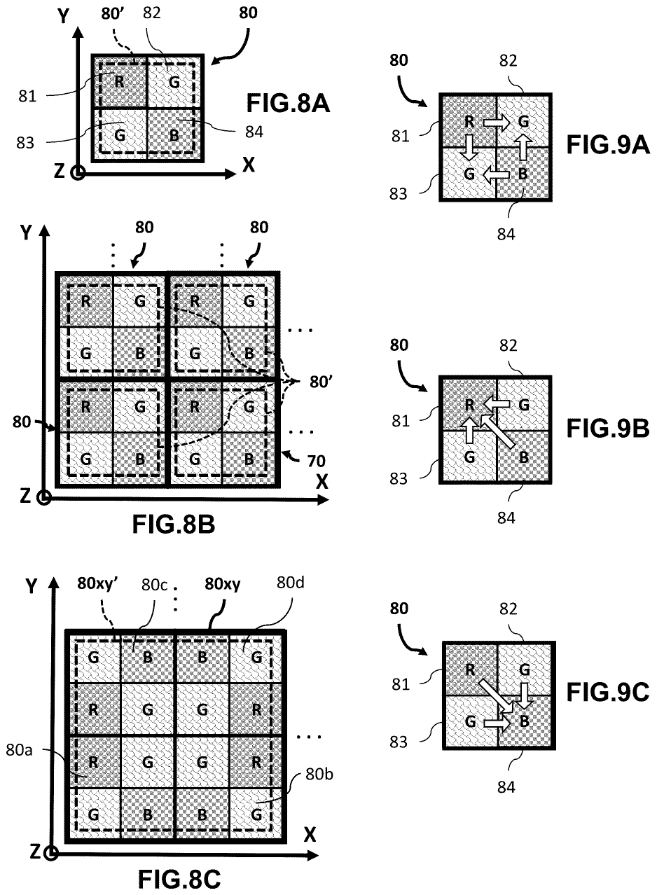

A non-limiting example of a basic wavelength optical router will be described below with reference to the diagrams in FIG. 8A to FIG. 8C. This router is designed to sort the incident light received at the input on the basis of its wavelength into three distinct colors: red, green, and blue. This elementary optical router has a 2×2 routing pattern.

The skilled person will appreciate that, regardless of the type of optical routing performed, the distinction between the two optical output zones of each pair or group of optical output zones of the elementary light routing pattern concerns, in practice, the optical characteristics (in terms of polarization or wavelength) of the light fluxes delivered by these optical output zones after the incident light flux has passed through the corresponding optical router. Stated otherwise, the selective effect of optical routing in polarization or wavelength results in heterogeneous characteristics of the pseudo “sub-fluxes” of light exiting the different optical output areas at the lower face of the optical router in question, i.e., below said optical router. These characteristics are specific to each optical output area, compared to the spatially homogeneous characteristics of the single light flux received by the optical input area at the upper face of the optical router, i.e., from above said optical router. In fact, the distribution of light at the output of the optical router is modified due to its passage through the nanostructure of the metasurface forming the optical router, compared to what it is at the input. This will be explained in detail below, with reference to the diagram in FIG. 3B.

It should be noted that the light routing device can advantageously be arranged directly above the photodetector array, so that the spatial separation of light as a function of polarization states or the spatial separation of light as a function of light wavelengths takes place directly at the sensitive surface of the optoelectronic sensor, at the pixel level.

The optical routing axis, or optical routing axes where applicable, i.e., the X-direction and/or Y-direction along which light deflection occurs, is particularly sensitive to the phenomenon of mutual coupling (“crosstalk”). This is why the main aim is to avoid mutual coupling in this axis.

We will now describe different ways of implementing the optical polarization-based or wavelength-based light routing device. Various examples of elementary routing patterns are explained, in particular for achieving different types of selective light routing (i.e., depending on different parameters of the incident light: polarization states or wavelengths), and/or having different N×M formats, some of which may comprise several combined binary routing patterns.

The first example given below will be detailed in order to explain the technical effects and advantages obtained through this method of implementation. Those skilled in the art will be able to extrapolate, from this relatively detailed explanation, the technical effects and advantages that can be obtained through the other methods of implementation, which will be described more succinctly below.

### Polarization-Based Router, 2×1 Format Pattern

FIG. 3A schematically shows, in top view, an elementary routing pattern 30′ for optical polarization-based routing of light. This is a binary routing pattern with a 2×1 format. The binary routing pattern 30′ comprises two distinct optical output areas that are aligned along one of the X and Y directions, namely the X direction in the non-limiting example shown. These optical output areas are:
a first optical output zone 31 that is adapted to output the portion of incident light having a specific polarization, for example linear polarization at 0°; and,
a second optical output zone 32 that is adapted to output the portion of light having orthogonal linear polarization, at 90° in this example.

The diagram in FIG. 3B shows a cross-section of a much simplified optoelectronic detector 40, such as a CMOS image sensor. The device 40 comprises a photodetector array 41 with at least two pixels 35 and 36 similar to pixels 25 and 26 shown above with reference to FIG. 2, which are adjacent in the X direction. The device 40 also comprises an optical polarization-based light routing device 42, formed directly above the photodetector array 41. The optical routing device 42 can receive a light flux 10 as input, which is symbolized, as in FIG. 2, by the series of vertical black arrows pointing from top to bottom to represent incident light at normal incidence, i.e., perpendicular to the upper surface of the detector 40. The device 42 further comprises an elementary optical router 30, which in this case is a binary optical light polarization router having the routing pattern shown in FIG. 3A. This optical router 30 comprises the two optical output areas 31 and 32, which are directly above pixels 35 and 36, respectively, of the underlying photodetector array 41.

As already indicated above, the distinction between the two optical output areas 31 and 32 of the routing pattern 30′ concerns in practice the characteristics (in terms of polarization, in this example) of the light output from the binary optical router 30, i.e., below said router after the incident light arriving at the input, i.e., from above the optical router 30, has passed through said router undergoing selective deflection. Indeed, the spatial distribution of the light at the output of the router (i.e., directly below the router 30, at the optical output areas 31 and 32 in the configuration as illustrated) is modified due to the nanostructure of the metasurface created by the binary routing pattern 30, compared to what it is at the input (i.e., above the router in the configuration as illustrated).

The binary optical router 30 is adapted to sort at the output, i.e., at the lower surface of said router, the incident light flux 10 as a function of the polarization state of the light. More specifically, the incident light 10 is separated into two pseudo optical “sub-flows,” symbolized by the thick black vertical arrows 11 and 12 at the optical output areas 31 and 32, respectively. The respective optical characteristics of the incident light flux 10 at the input and the two optical “sub-fluxes” delivered by the optical outputs 11 and 12 differ substantially in terms of the polarization of the light:
the incident light flux 10 at the input is essentially homogeneous in terms of light polarization, in that the polarization states at 0° and 90° are mixed therein; whereas,
the overall output light flux is substantially inhomogeneous in terms of light polarization, as it is formed:
   a first “sub-flow” of output light, delivered by the optical output area 11 and comprising essentially the incident light having a specific polarization (namely linear polarization at 0° in the example) and directed toward the sensitive surface of a specific first pixel, namely the left pixel 35 in the example; as well as
   a second “sub-flow” of output light, delivered by the optical output area 12 and comprising essentially the incident light having orthogonal polarization (and more particularly linear polarization at 90° in the example) and which is directed toward the sensitive surface of another pixel, namely the right-hand pixel 36 in the example.

The 30′ binary routing pattern of the optical polarization-based light router 30 is, for example, realized in the form of a metasurface specially adapted for polarization-based light routing in the X direction, i.e., the selective deflection of light along said X direction, depending on its polarization state among the two orthogonal linear polarization states, at 0° and 90°, respectively. In the example shown, this X direction is, in fact, the direction along which the optical output areas 31 and 32 of the binary routing pattern 30 are aligned, side by side. In other words, the binary routing pattern 30 comprises the two optical output areas 31 and 32 arranged adjacently and contiguously along the X direction, and these optical output areas each deliver, respectively, the portion of the light having a determined linear polarization, namely polarization at 0°, and the portion of the light having an orthogonal linear polarization, namely polarization at 90°.

Functionally, the two optical output areas 31 and 32 of the base pattern 30 are each associated with one of the two photodetectors (pixels) 35 and 36, which are arranged below said areas, as shown. These pixels 35 and 36 ideally have dimensions in the (X,Y) plane that correspond to those of the optical output areas 31 and 32, respectively, both in the X direction and in the Y direction. As illustrated in FIG. 3B, the optical output area 31 and the optical output area 32 of the binary router 30 deflect the incident light, depending on whether its polarization is at 0° or 90°, either towards pixel 35 or towards pixel 36, respectively. In operation, the photodiodes of pixels 35 and 36 produce respective electron fluxes, i.e., respective optoelectronic detection currents, which are a function of the number of photons that have been deflected by the optical router 30 from the incident light 10, i.e., which depend on the light intensity of the linearly polarized light at 0° for pixel 35, and of the linearly polarized light at 90° for pixel 36, respectively.

In summary, in the optoelectronic detector 40, each of the optical output areas 31 and 32 of the basic pattern 30′ of the optical router 30 is associated, in the sense defined in the previous paragraph, with a respective photodetector of said detector 40, namely a pair of pixels comprising pixel 35 and pixel 36 in the example considered. And these pixels 35 and 36 are arranged in the same layout, in N×M format and in this case in 2×1 format, as the optical output areas 31 and 32 of the binary routing pattern 30′ of the optical polarization-based light router 30. In addition, each of the optical output areas 31 and 32 of the base pattern 30′ has respective light routing properties for a given linear polarization state, namely 0° and 90° in this example. It goes without saying that, in a variant, the 2×1 pattern of these figures could just as well be designed to selectively deflect light according to two other types of crossed linear polarization, such as, for example, according to orthogonal linear polarization states at 45° and 135°, respectively. Similarly, in another variant, the 2×1 pattern of FIG. 3A and FIG. 3B could also be designed to selectively deflect light according to the states of right circular polarization (RCP) and left circular polarization (LCP), respectively.

With reference to FIG. 3C, a conventional polarization-based light routing nanostructure can comprise an array of elementary optical routers 30 formed by spatially repeating (or replicating) a predetermined number K1 of times in a predetermined direction, in this example the X direction, of the binary routing pattern 30 of FIG. 3A. The K1 binary routing patterns 30 thus aligned in the X direction are contiguous two by two. In other words, they are not spaced apart in the X direction. The X direction is preferably the direction of light routing, this direction being determined by the size and spatial distribution of the nanopillars of the metasurface that implements the binary routing pattern 30 with the optical output areas 31 and 32. The number K1 is substantially equal to the ratio of the size of the sensitive surface of the optoelectronic detector in the X direction of alignment to the size of the binary routing pattern 30 in said X direction. For example, considering that the length L1 in the X direction of each of the two pixels 35 and 36 which are arranged under the areas 31 and 32 of the polarization-based routing pattern 30 (see FIG. 2) is substantially equal to 4 μm, and that the length of the sensitive surface of the optical detector in said X direction is substantially equal to 5 mm, then the number K1 is substantially equal to 625 (K1=625), given that 5 mm/(2×4 μm)=625.

FIG. 3D is a schematic bottom view representation similar to that of FIG. 3C showing the optical router 30 described above. However, this new figure shows an optical polarization-based light routing device in accordance with proposed embodiments for reducing mutual coupling between pairs of pixels that are adjacent to each other in the X direction of optical routing. According to these embodiments, the routing device still comprises an arrangement formed by the spatial repetition of a basic optical router 30x in the same routing direction as in FIG. 3B, i.e., the X direction in this example. However, this arrangement here includes the replication, K2 times, of a basic 30x′ routing pattern, which differs from the basic 30′ routing pattern of the basic router 30 in FIG. 3C. This new basic 30x′ routing pattern is symmetrized along the X direction and has a 4×1 format. This basic routing pattern 30x′ is said to be symmetrized along the X direction in that it combines, aligned contiguously along said X direction:
a first binary routing pattern 30a corresponding to the binary routing pattern 30′ of FIG. 3A; and,
a second binary optical routing pattern 30b which is a “mirrored” version, following the X alignment direction, of said binary routing pattern 30′ of FIG. 3A.

As will be understood, in this example the number K2 corresponds to half of K1 (K2=K1/2). The second binary optical routing pattern 30b is arranged “mirrored” from the first binary optical routing pattern 30a in the X direction, in that the routing pattern 30b is the image (or reflection) of the routing pattern 30a, and vice versa, by orthogonal symmetry with respect to a plane P in 3-dimensional Euclidean space, which is orthogonal to the X-direction of alignment of these two adjacent routing patterns 30a and 30b. This Euclidean relationship is called symmetry or reflection of plane P.

The combination of routing patterns 30a and 30b arranged side-by-side and “head-to-tail” in the X direction forms a basic pattern 30x′ which is repeated spatially, identically, to cover all or part of the sensitive surface of the photoelectric detector in the X direction. The basic routing pattern 30x′ has a 4×1 format. It is said to be “symmetrical in the X direction” because it is the image of itself by the aforementioned P-plane symmetry, said P-plane being the plane orthogonal to the X alignment direction of the elementary routers 30a and 30b, which is located between said elementary routers.

In practice, in an optical polarization-based light routing device according to this embodiment, basic optical routers 30x having the basic routing pattern 30x′ of 4×1 format presented above are replicated, also following the other Y direction of the [X,Y] plane of the sensitive surface of the optoelectronic detector incorporating the device, to form a two-dimensional mesh covering at least part, and ideally the entirety, of this sensitive surface. This replication of the basic router in the Y direction is not visible in FIG. 3D, which illustrates the replication of the symmetrized basic optical router 30x only in the X routing direction, so as not to overload this figure.

The person skilled in the art will appreciate that the elementary optical router 30 of FIG. 3B having a 2×1 routing pattern 30′, the basic optical router 30x in FIG. 3D, which is a symmetrized optical router obtained by arranging two such routers adjacent to each other and mirrored with respect to each other along the X direction, has a symmetrized basic routing pattern 30x′ that is 4×1 in format. But, more generally, if the elementary optical router has a routing pattern of format N×M, then the basic optical router has a symmetrized basic routing pattern of format 2N×M in the case of unidirectional symmetrization along the X axis as shown. It can also be of format N×2M in the case of unidirectional symmetrization along the Y axis, and of format 2N×2M in the case of bidirectional symmetrization along both the X and Y axes.

It will now be explicated, by comparing FIG. 4A and FIG. 4B, how the symmetry of the 30x′ basic routing pattern of the symmetrized 30x basic optical router illustrated in FIG. 3D reduces the mutual coupling (or cross-coupling) between adjacent pixels in an optical polarization-based light routing device, compared to the basic routing pattern 30′ of the basic optical router 30 in FIG. 3C. It should be noted that, in the non-limiting example of these figures, for the sake of simplicity, only a single optical routing direction and a single replication direction of the basic routing pattern are considered, which in both cases is the X direction. The person skilled in the art will be able to generalize this description to the case of replication of the basic routing pattern in both the X and Y directions.

FIG. 4A is a simplified vertical cross-sectional diagram of an optoelectronic detector 40 comprising a matrix of photodetectors 41 on one side and, above said matrix 41, an optical polarization-based light routing device 42 on the other side. Device 42 comprises a conventional arrangement of identical elementary routers, namely binary routers 30 as shown in FIG. 3C, which are spatially repeated to cover part of the sensitive surface of the photodetector array 41, being aligned in at least one given direction, namely the X direction in this case.

If one considers only the pseudo “sub-flow” of light that comprises the portion of incident light 10 that has a polarization state at 90° it can be observed that only a significant portion of this “sub-flux,” represented by the thick vertical arrow pointing from top to bottom, is directed toward the pixel located below the corresponding optical output area of the routing pattern 30′, which pixel is dedicated to detecting incident light polarized at 90° (i.e., the right-hand pixel in the example). However, a small part of this “sub-flow” is directed toward a neighboring pixel in the X routing direction, i.e., on the left side in FIG. 4A, and another small part of this “sub-flow” is directed toward the other neighboring pixel in said X direction, i.e., on the right side in FIG. 4A, due to the inherent phenomenon of cross-coupling. These two respective minority portions of the “sub-stream” of incident light 10, which comprise light in a 90° polarization state, are represented by thinner arrows, which are oriented across to the left and across to the right, respectively, in FIG. 4A. Now, these two neighboring pixels, on the left and on the right, are dedicated to detecting the crossed polarization state, i.e., detecting the incident light polarized at 0° in the example. In other words, the minority photons of the “sub-flow” of light polarized at 90° that are deflected toward the left pixel and toward the right pixel are lost for detection by the center pixel, which is dedicated to detecting light with this polarization. Furthermore, these photons interfere with the detection of light polarized at cross polarization, i.e., polarized at 0°, in the two neighboring pixels dedicated to detecting said cross polarization.

Those skilled in the art will appreciate that, due to the same phenomenon of reciprocal coupling between adjacent pixels, a minority of photons in the 0° polarization state are not oriented toward a pixel in the array of photodetectors 41 that is dedicated to detecting this polarization, but are oriented in one or other of the adjacent pixels along the X direction that are dedicated to detecting cross polarization, i.e., detecting 90° polarization in the example. This phenomenon is not shown in FIG. 4A. Furthermore, it goes without saying that, in the case of an optoelectronic detector having an optical light routing device with a basic routing pattern that is spatially repeated in both the X and Y directions, the same phenomenon of mutual coupling between adjacent pixels also occurs simultaneously between pixels that are adjacent in the other direction, namely the Y direction in the example.

As can be understood, the reciprocal coupling between adjacent pixels significantly reduces the PER of each of the pixels in the matrix of photodetectors in the optoelectronic detector 40.

FIG. 4B is a simplified vertical cross-sectional diagram of an optoelectronic detector 40″ comprising a matrix of photodetectors 41″ and, above said matrix 41″, an optical polarization-based light routing device 42″ as shown in FIG. 3D. This figure illustrates the replication, aligned in the X direction and contiguous two-by-two along said direction, of a plurality of basic routers 30x that are symmetrized, precisely, along this X alignment direction, which is also the direction of optical routing in the elementary routers (binary routers here). These are basic optical routers having the basic 30x′ routing pattern in 4×1 format already shown in FIG. 3A. This replication consists of spatially repeating, in the X direction in this case, the symmetrical basic routing pattern 30x′ to cover at least part of the sensitive surface of the photodetector array 41′. FIG. 4B shows a single basic optical router 30x in its entirety and half of another basic optical router 30x on the right, along the X direction.

In accordance with the teaching of the invention, the phenomenon of reciprocal coupling between adjacent pixels, which was explained above with reference to FIG. 4A, causes some of the light polarized at 90° that is delivered by the optical output area but is not directed toward the underlying pixel dedicated to detecting light with this polarization to nevertheless reach an adjacent pixel dedicated to detecting said polarization. This result is obtained due to the fact that, thanks to the mirroring of two elementary optical routers 30a and 30b (see FIG. 3D) along the X direction to form the base router 30x with a base routing pattern 30x′ that is symmetrical along said X direction, two pixels dedicated to detecting light at the same polarization state are adjacent to each other. Thus, with reference to FIG. 4B, a portion of the light “sub-flow” represented by the narrow arrows, which represent a portion of the incident light 10 that is in the 90° polarization state, is directed toward an adjacent pixel that is dedicated to detecting said polarization.

According to the proposed solution, the elementary routers are arranged in such a way that two adjacent elementary routers are mirrored to each other along the X direction. In other words, each of these two routers is the mirror image of the other with respect to a plane of symmetry that is orthogonal to the direction X of alignment of the routers, at their separation (i.e., at their common separating boundary) along said direction. This results in an induced placement of pairs of pixels dedicated to detecting light at a given polarization, whereby these pixels are arranged side by side along the direction X of alignment of two elementary routers within the base router.

Thus, even in the event of reciprocal coupling between pixels, some (approximately half) of the light having a specific polarization and which is deflected beyond the pixel towards which it is routed by an elementary router 30a or 30b will still illuminate an adjacent pixel that is also dedicated to detecting light having that polarization. The PER will therefore be less degraded thanks to this arrangement.

Those skilled in the art will appreciate that although the alignment and mirrored arrangement of adjacent elementary routers only in the X direction is considered in the above, the format of the elementary pattern of an elementary router and the arrangement of the elementary routers can be transposed to the other direction defining, together with said X direction, the [X,Y] plane of the sensitive surface of the optical detector, namely the Y direction in the example. The format of the elementary routing pattern 30′ of the elementary routers 30 considered is then a 1×2 format instead of a 2×1 format and, as a corollary, the associated pixel pairs are adjacent pixels in the other Y direction of the [X,Y] plane of the sensitive surface of the optical detector.

In summary, the proposed arrangement of elementary routers reduces the effect of crosstalk between adjacent pixels, thereby improving the PER. By mirroring the elementary pattern 30 in the symmetrical base pattern 30x, crosstalk will have less impact on the PER. It is certainly not possible to eliminate crosstalk in the pixels adjacent to both sides (laterally) of a given pixel, but the impact of crosstalk on PER is nevertheless significantly reduced. This mirroring produces a technical effect that is specific to the solution to the technical problem of reducing the disadvantages of reciprocal optical coupling between adjacent pixels while benefiting from the advantages of optical routing, compared to optical filtering, in relation to the sensitivity of the optoelectronic detector, as explained in the introduction.

Another advantage of the basic routing pattern symmetrization concerns phase design. Even though the primary intention is to reduce the impact of reciprocal coupling between adjacent pixels, it has been observed that spatially repeating basic routers with a symmetrical basic routing pattern also eliminates phase jumps in the light along the direction of alignment of said routers at the interface between adjacent basic routers.

Indeed, when basic optical routers formed by juxtaposing two binary polarization routers mirrored to each other along the routing direction X are created with metasurfaces, these metasurfaces reproduce different wavefronts for the two orthogonal polarizations. These wavefronts are illustrated by the curves in FIG. 5A for optical router 30, whose basic routing pattern is shown in FIG. 3A, which includes the two pixels 35 and 36 in FIG. 3B that are adjacent in the routing direction X. FIG. 5A shows, on the x-axis, the spatial position along the routing direction X for a portion of the optoelectronic detector surface at pixels 35 and 36. The phase of the light, between 0 and 2π, is shown on the y-axis. The regular dotted vertical lines are the pixel boundaries, and the alternating long and short dotted vertical lines indicate the centers of pixels 35 and 36. A basic metasurface covers a pixel such as the left pixel 35 dedicated to detecting polarization at 0°, as well as a pixel such as the right pixel 36 dedicated to detecting polarization at 90°.

More specifically, curve 51 shows the evolution of phase Φp0 of light with polarization p0, which is linear polarization at 0°, and curve 52 shows the evolution of the Φp90 phase of light with p90 polarization, which is linear polarization orthogonal at 90°, as a function of position along the routing direction X along the portion of the detector under consideration, i.e., at pixels 35 and 36. The phase profiles are spherical profiles. In this example, the wavefront 51 must cause the light polarized at 0° to converge in the left pixel 35, while the wavefront 52 must cause the light polarized at 90° to converge in the right pixel 36. Those skilled in the art will appreciate that phase curves 51 and 52 illustrate the evolution of the phase of the electric and magnetic components of light, following the X direction of optical routing in light polarization in the optical detector.

When the basic routing pattern 30′ is repeated by aligning 30 identical optical routers over at least part of the length of the optoelectronic sensor in the X direction, this creates phase discontinuities in the X direction. Such a phase discontinuity is illustrated by reference 55 on curves 51 and 52 in FIG. 5B for two routers aligned in the X direction without implementing the invention. In other words, when the phase profiles of the base pattern are replicated in the X direction, a phase jump appears at the boundary between two contiguous metasurfaces in said X direction. Such phase discontinuities can be detrimental to the efficiency of optical routing.

When using the basic routing pattern symmetrized by mirroring two adjacent elementary routers along the routing direction X, phase jumps are reduced or even eliminated, as shown by reference 55x on curves 51x and 52x in FIG. 5C, which correspond to curves 51 and 52, respectively, in FIG. 5A and FIG. 5B. In addition, this avoids conflicts at the edges of metasurfaces. Typically, nanopillars are used to modify the phase as desired. However, the nanopillars placed at the edges of the portions of the metasurface associated with the underlying pixels generally pose a problem because, with reference to curves 51 and 52 in FIG. 5A, they must provide a phase of 0° for the left pixel 35 but a phase of 90° for the right pixel 36. This results in a local incompatibility. The mirrored pattern resolves the conflict and allows the nanopillars placed at the edges of the metasurface portions associated with the underlying pixels 35 and 35 to be shared for the generation of the two phases at 0° and 90°, respectively.

In summary, in phase profiles 51′ and 52′ of the basic routing pattern formed by two binary routing patterns arranged in mirror image to each other along the X direction, the phase jump 55 visible in FIG. 5B is eliminated, which makes it possible to share the nanopillar at the boundary between the two corresponding metasurfaces, which are adjacent along said X direction.

The principle behind the invention was tested in a simplified simulation and then in a full simulation on a real pixel, for example a Fox™ pixel from the company STMicroelectronics®.

The so-called “simplified” simulations include only the metasurface and the pedestal. PER performance is calculated by integrating the square of the electric field modulus at the bottom of the pedestal (at the top surface of the pixel, but without simulating it).

So-called “complete” simulations also include the simulation of optical propagation in a fully modeled CMOS pixel, i.e., with modeling of the photodiode, metallization levels, shallow trench isolation (STI), etc. The PER is calculated by the percentage of light absorbed in the photodiode, as explained above. These are optical simulations only, not electrical ones, but it is assumed that the number of photons absorbed by the photodiode is proportional to the number of electrons generated.

In a simplified simulation, a meta-surface measuring 5.22 μm×2.61 μm was simulated on a pedestal made solely of SiO2, and the optical intensity (absorbed energy) was measured on the right and left sides of a binary router simulated in this way. A gain of +15% was observed on the left pixel 35 and a gain of +6% on the right pixel 36, with a basic optical router with a basic 30x′ routing pattern symmetrized relative to a basic optical router with a basic 30′ routing pattern not symmetrized, as reflected by data in the table below.

TABLE 1

| | Left pixel PER | right pixel PER |
|---|---|---|
| Non-symmetrized basic pattern | 3.55 | 4.12 |
| Symmetrized basic pattern | 4.12 | 4.39 |

In a complete simulation, the metasurface was placed on a 2.61 μm Fox™ pixel from STMicroelectronics® (i.e., a metasurface measuring 5.22 μm×2.61 μm) and the energy absorbed by the silicon photodiode was measured. Once again, a gain of approximately 15% was obtained on the left pixel and approximately 34% on the right pixel, as reflected by data in the table below.

TABLE 2

| | Left pixel PER | right pixel PER |
|---|---|---|
| Non-symmetrized basic pattern | 1.86 | 1.775 |
| Symmetrized basic pattern | 2.13 | 2.38 |

It therefore appears that the improvements in PER observed in simplified simulations result from the elimination of the phase jump, which is achieved through the implementation of the invention: the phase becomes continuous and the metasurface functions better optically.

The PER improvements observed in full simulation are due to both the elimination of phase shift (see above) and the attenuation of reciprocal coupling between adjacent pixels, which is due to the fact that half of the “cross talk” of polarization at 0° still falls within a pixel dedicated to detecting polarization at 0°, instead of falling within a pixel dedicated to detecting polarization at 90°).

### Polarization-Based Router, 2×2 Pattern

If several different pairs of polarization states must be discriminated by routing in a particular application under consideration, an elementary optical router can be defined, formed by the combination of as many respective binary routers that share the same optical input. For example, the drawings in FIG. 6A to FIG. 6C illustrate an elementary polarization-based router 60 comprising two binary routers adapted to separate, at the output, two pairs of crossed polarization states present in the incident light. In this case, these are two linear polarizations that are orthogonal to each other, namely in this example:
the states of linear polarization at 0° and 90°; and,
the states of linear polarization at 45° and 135°.

In the non-limiting example shown in the drawings of FIG. 6A, the elementary routing pattern 60′ of the binary router is formed by the juxtaposition, in the Y direction, of two binary routing patterns 60-1 and 60-2, respectively. These two binary routing patterns are respectively adapted to separate orthogonal linear polarization states at 0° and 90°, on the one hand, and orthogonal linear polarization states at 45° and 135°, on the other hand. To this end, binary pattern 60-1 comprises two optical output zones 61 and 62, which are adjacent in the X direction, which is the direction of optical polarization-based routing of light. The binary pattern 60-2 also comprises two optical output areas 63 and 64, which are adjacent in the X direction. The binary routing patterns 60-1 and 60-2 are 2×1 format patterns.

The basic routing pattern 60′ is an example of a regular routing pattern, i.e., an N×M format with N=M. This non-limiting example is a quaternary optical routing pattern, i.e., a routing pattern with four optical outputs, which are optical output areas 61, 62, 63, and 64. It is a square routing pattern, i.e., a 2×2 format with four optical output areas arranged in a square (i.e., also in two rows and two columns). Of course, a regular routing pattern (i.e., a routing pattern whose optical output areas are arranged in a square) according to the invention is not intended to be limited by the number of optical output areas or by the specific values of cross-polarization states indicated above, which are given only as examples and are not limiting.

FIG. 6B shows a partial top view of a polarization-based light routing device comprising an array of elementary routers 60 formed by spatially repeating the 2×2 routing pattern of FIG. 6A in at least one specific direction, which is preferably the routing direction X. In the example shown, the elementary routers 60, all having the same elementary routing pattern 60′, are the basic optical routers that are replicated to cover at least part of the sensitive surface of the optoelectronic detector. In the example shown, the basic optical routers 60 are spatially repeated both in the X direction and in the Y direction, which define the plane of the sensitive surface of said optoelectronic detector. The skilled person will appreciate that, in the optical polarization-based light routing device of FIG. 6B, no pixel associated with an optical output area of the routing patterns of the optical routers juxtaposed in the X direction and in the Y direction is contiguous with another pixel dedicated to detecting light with the same polarization as itself. The reciprocal coupling between adjacent pixels in the X direction or in the Y direction fully impacts the PER of each of the pixels.

FIG. 6C shows, in partial top view, a polarization-based light routing device comprising, like the one shown in FIG. 6B, an array of basic routers 60x formed by spatially repeating such basic routers both in the X direction and in the Y direction. However, in accordance with embodiments of the invention, the basic router 60x comprises two quaternary routers 60a and 60b like the quaternary router 60 of FIG. 6A, but arranged side by side and mirrored with respect to each other in a predetermined direction, which is preferably the X routing direction. The basic routing pattern 60x′ of this basic router 60x therefore comprises eight optical output zones and has a 4×2 format. The mirroring of the two quaternary routers 60a and 60b along the X direction gives the basic optical router 60x symmetry along the X direction. In other words, the basic optical router 60x is symmetrical along the X direction. It is referred to as being unilaterally symmetrized, since it is symmetrical in only one of the two directions, X and Y.

Comparing the diagrams in FIG. 6A and FIG. 6C, it will be noted that in the routing device of FIG. 6C, a basic optical router 60x comprises optical output areas associated with adjacent pixels dedicated to detecting light having the same polarization, which are contiguous in the X direction: in the example shown, these are the optical output areas delivering light polarized at 90° and the optical output areas delivering light polarized at 135°. In addition, the routing device of FIG. 6C includes other pairs of adjacent pixels dedicated to detecting light having the same polarization that are contiguous in the X direction: in the example shown, these are the optical output areas delivering light polarized at 0° and the optical output areas delivering light polarized at 45°, which are on the respective contiguous edges of two symmetrized optical routers 60x adjacent in the X direction. This contiguity between optical output zones associated with pixels dedicated to detecting light with the same polarization is provided by the symmetry of the basic optical routers 60x, which are duplicated along said X direction. These contiguities improve the PER by attenuating the effect of the inherent reciprocal coupling between adjacent pixels in the X direction.

FIG. 6D shows, in partial top view, a light polarization routing device comprising, like the one shown in FIG. 6B and the one in FIG. 6C, an arrangement of basic routers 60xy formed by spatially repeating such basic routers both in the X direction and in the Y direction (for reasons of space availability, only one basic router 60xy is shown, but ellipses indicate the spatial repetition of this basic router in the X direction and in the Y direction). In accordance with other embodiments of the invention, the basic router 60xy comprises four quaternary elementary routers 60a, 60b, 60c, and 60d like the quaternary elementary router 60 of FIG. 6A, but arranged adjacent to each other in pairs and mirrored in pairs both in the X routing direction and in the perpendicular Y direction. The basic routing pattern 60xy′ of this basic router 60xy therefore comprises sixteen optical output zones associated with sixteen respective pixels of the detector's pixel matrix. This routing pattern is 4×4 in format. Mirroring the four quaternary elementary routers 60a, 60b, 60c, and 60d along the X direction and along the Y direction gives the basic optical router 60xy symmetry along each of the two directions X and Y. In other words, the basic optical router 60xy is symmetrical along both the X direction and the Y direction. In other words, the basic optical router 60xy is symmetrical in both the X and Y directions.

Comparing the diagram in FIG. 6D with that in FIG. 6C, it will be noted that in the router 60xy of FIG. 6D, the number of optical output areas of the bilaterally symmetrized basic routing pattern 60xy′ that are associated with pixels dedicated to detecting light with the same polarization and that are contiguous in the X direction and/or the Y direction within said symmetrized basic routing pattern 60xy′, is increased very significantly compared to the unilaterally symmetrized basic routing pattern 60x′ of FIG. 6C. Of course, this number is even more increased compared to the unsymmetrized basic routing pattern 60′ of FIG. 6B.

Indeed, each pixel of the optoelectronic detection device according to FIG. 6D is contiguous with at least one other pixel dedicated to detecting light having the same polarization as itself, within the pixels associated with the optical output areas of the symmetrized basic routing pattern 60xy′ (except for the optical output areas at the four corners of said patterns, whose associated pixels are dedicated to detecting 45° linear polarization in the example shown).

Even better, by extrapolating the repetition of the basic 60xy′ routing pattern symmetrical in both the X and Y directions, one can observe that each pixel of the optoelectronic detection device will be contiguous with at least one other pixel dedicated to detecting light with the same polarization as itself. This optimal result stems from the fact that the basic routing pattern 60′ is regular, i.e., it is a square pattern, of the 2×2 type in this example. All these contiguities improve the PER by attenuating the effect of the inherent mutual coupling between adjacent pixels in the X direction and in the Y direction.

### Polarization-Based Router, 2×3 Pattern

As already mentioned above, the diagrams in FIG. 7A to FIG. 7D illustrate another example of an elementary optical router 70, which is adapted to sort the incident light received at the input according to its polarization among six polarization states, which are crossed two-by-two, namely:
linear polarization at 0° and orthogonal linear polarization at 90°,
45° linear polarization and 135° orthogonal linear polarization, and finally,
left-hand circular polarization (LCP) and right-hand circular polarization (RCP).

FIG. 7A shows a schematic top view of such a basic 2×3 senary routing pattern, which can be achieved by a metasurface similar to that of FIG. 2, for use in the polarization-based optical routing device of an optoelectronic detector. This senary optical router 70 has an irregular 2×3 routing pattern 70′. It comprises three binary optical routers 70-1, 70-2, and 70-3, each of which has a 2×1 binary routing pattern, said three binary optical routers being aligned in a column in the Y direction. The binary routing pattern of the binary optical router 70-1 has two optical output areas 71 and 72, adjacent in the X direction. Similarly, the binary routing pattern of binary optical router 70-2 has two optical output areas 73 and 74, adjacent in the X direction. Similarly, the binary routing pattern of binary optical router 70-3 has two optical output areas 75 and 76, adjacent in the X direction.

The above binary routing patterns of binary routers 70-1, 70-2, and 70-3 are respectively adapted to separate each pair of different crossed polarization states of light. These may be, in particular, two linear polarizations that are orthogonal to each other and/or two circular polarizations, namely, in one example:
the linear polarization states at 0° and 90°, for the binary router 70-1, respectively;
the 45° and 135° linear polarization states, for the binary router 70-2; and/or,
right circular polarization (or RCP) and left circular polarization (or LCP) states for the 70-3 binary router.

The basic routing pattern 70′ is an example of an irregular routing pattern, i.e., an N×M format with N‡M. This non-limiting example is a senary optical routing pattern, i.e., a routing pattern with six optical outputs, which are optical output zones 71 to 76. It is a rectangular routing pattern, i.e., with an equal number of N×M optical output zones arranged in M rows and N columns. Of course, an irregular routing pattern (i.e., a routing pattern in which the optical output zones are arranged in a rectangle) according to the invention is not intended to be limited either by the number of optical output zones or by the specific values of cross-polarization states indicated above, which are given purely by way of example and are not limiting.

The diagram in FIG. 7B shows, in partial top view, a light polarization routing device comprising an array of elementary routers formed by spatially repeating the 2×3 routing pattern of FIG. 7A both in the X direction and in the perpendicular Y direction. As shown, the elementary routers 70 all have the same elementary routing pattern 70′. They are replicated bidirectionally to cover at least part of the sensitive surface of the optoelectronic detector. Those skilled in the art will appreciate that, in the light polarization optical routing device of FIG. 7B, no pixel associated with an optical output area of the routing patterns 70′ of the optical routers 70 juxtaposed in the X direction and in the Y direction is contiguous with another pixel dedicated to detecting light with the same polarization as itself. The reciprocal coupling between adjacent pixels in the X direction or in the Y direction fully impacts the PER of each of the pixels.

The diagram in FIG. 7C shows, in partial top view, a light polarization routing device comprising, like the one shown in FIG. 7B, an array of basic routers 70x formed by spatially repeating such basic routers both in the X direction and in the Y direction. However, in accordance with embodiments of the invention, this basic router 70x comprises two senary routers 70a and 70b like the senary router 70 of FIG. 7A, but arranged side by side and mirrored with respect to each other in a predetermined direction, which is preferably the X routing direction. The basic routing pattern 70x′ of this basic router 70x therefore comprises twelve optical output zones and has a 4×3 format. The mirroring of the two 70a and 70b routers along the X direction gives the 70x basic optical router symmetry along the X direction. In other words, the 70x basic optical router is symmetrical along the X direction, being unilaterally symmetrized along only one of the two directions X and Y.

Finally, the diagram in FIG. 7D shows, in partial top view, a light polarization routing device comprising, like the one shown in FIG. 7B and the one shown in FIG. 7C, an arrangement of basic routers 70xy formed by spatially repeating such basic routers both in the X direction and in the Y direction (again, for reasons of space in the drawings, only one basic router 70xy is visible in FIG. 7D). However, in accordance with other embodiments of the invention, the basic router 70xy comprises four quaternary elementary routers 70a, 70b, 70c, and 70d like the senary elementary router 60 of FIG. 7A, but arranged adjacent to each other in pairs and mirrored in pairs both in the X routing direction and in the perpendicular Y direction. The basic routing pattern 70xy′ of this basic router 70xy therefore comprises twenty-four optical output areas associated with twenty-four respective pixels of the detector's pixel matrix. This routing pattern is 4×6 in format. Mirroring the four basic senary routers 70a, 70b, 70c, and 70d along the X direction and along the Y direction gives the basic optical router 70xy symmetry along each of the two directions X and Y. In other words, the basic optical router 70xy is bilaterally symmetrical, being symmetrical in both the X direction and the Y direction.

By comparing the diagram in FIG. 7C with that in FIG. 7B, and by comparing the diagram in FIG. 7D with that in FIG. 7C and with that in FIG. 7B, the same advantages can be seen with regard to attenuating the effect of mutual coupling between adjacent pixels in the photodetector array as those noted above when comparing the diagrams in FIG. 6D, FIG. 6C, and FIG. 6D.

However, the skilled person will note that in the device of FIG. 7D, each pixel is contiguous, in the X direction and/or in the Y direction, to another pixel dedicated to detecting light with the same polarization as itself, but that, unlike in the case of FIG. 6D, not all pixels are contiguous, both in the X direction and in the Y direction, to such another pixel. This is due to the fact that the elementary routing pattern 70′ of the elementary optical router 70 in FIG. 7A is not regular. This pattern is rectangular with a 2×3 format, i.e., an N×M format with N different from M (N‡M). Nevertheless, the effect of mutual coupling between adjacent pixels is substantially attenuated compared to an optical routing device whose basic routing pattern is not symmetrized in accordance with the embodiments of FIG. 7C and FIG. 7D.

### Wavelength-Based Router, 2×2 Pattern

Another optical characteristic on the basis of which light can be selectively routed is wavelength. The technical teaching of the present disclosure also applies to optical routing based on the wavelength of light, i.e., to optical routers whose routing pattern has at least two optical output areas, each of which is associated with a specific wavelength, for example, one of the wavelengths corresponding to the colors red, green, and blue, respectively.

FIG. 8A is a schematic representation, viewed from above, of a 2×2 format 80′ wavelength routing pattern of an optical routing device 80 that can also be implemented by a metasurface in an optical detector similar to that of FIG. 2. According to this example, the 80 wavelength optical router has a 2×2 quaternary 80′ elementary routing pattern, i.e., an elementary routing pattern with one optical input and four optical outputs arranged in a square. These four optical output areas 81, 82, 83, and 84 are arranged in two rows extending in the X direction and two columns extending in the Y direction.

The optical output areas of the routing pattern 80′ include:
an optical output area 81 that is operatively coupled to a pixel of the underlying array of photodetectors that is dedicated to detecting light at the wavelength corresponding to the red color,
two other optical output areas 82 and 83 that are diametrically opposite each other and are respectively operatively coupled to two pixels of the underlying array of photodetectors dedicated together to detecting light at the wavelength corresponding to the green color,
another optical output area, i.e., the fourth and last optical output area 84 of the quaternary routing pattern, which is operatively coupled to a pixel of the underlying array of photodetectors that is dedicated to detecting light at the wavelength corresponding to the blue color.

The person skilled in the art will appreciate that, with regard solely to the spatial arrangement aspect, the quaternary 80′ routing pattern is similar to a Bayer filter pattern conventionally used to filter light by wavelength in CMOS image sensors. In particular, consideration may be given to the XTrans™ pattern from FUJIFILM disclosed in document WO2023275032A1 and mentioned in the introduction. For this reason, and by analogy, the 80′ routing pattern of the 80 wavelength optical router in FIG. 8A can be seen as, and referred to as, a wavelength routing pattern “of the Bayer R-V-V-B pattern type.”

The basic 80′ routing pattern is an example of a regular wavelength routing pattern, i.e., an N×M format with N=M. This non-limiting example is a quaternary optical routing pattern, i.e., a routing pattern with four optical outputs, which are optical output zones 81, 82, 83, and 84, but adapted to sort light according to a smaller number of different wavelengths, namely three wavelengths in this example. It follows, as already mentioned, that two of the four optical output areas are coupled to pixels dedicated to detecting the same wavelength (in this case, the green wavelength, in the example considered). This is a square routing pattern, i.e., a 2×2 format with four optical output areas arranged in a square (in two rows and two columns). Of course, a wavelength routing pattern is not necessarily a regular pattern (i.e., a routing pattern in which the optical output areas are arranged in a square). It can also be an irregular routing pattern, with the optical output areas arranged in a rectangle. More generally, it goes without saying that a wavelength-based light routing device according to embodiments of the invention is not limited by the number or spatial arrangement of the optical output areas or by the specific values of the wavelengths indicated above, of the example of the wavelength-based routing pattern 80′, which are given purely by way of example and are not limiting.

FIG. 8B is a schematic representation, viewed from above, of a wavelength-based light routing device comprising an array of elementary routers 80 formed by the contiguous repetition of the 2×2 routing pattern of FIG. 8A in both the X direction and the perpendicular Y direction, without implementing the symmetrization in accordance with embodiments of the invention.

It will be appreciated that, in the optical wavelength-based light routing device of FIG. 8B, no pixel associated with an optical output area of the routing patterns 80′ of the optical routers 80 juxtaposed in the X direction and in the Y direction is contiguous with another pixel dedicated to detecting light with the same wavelength as itself. The reciprocal coupling between adjacent pixels in the X direction or in the Y direction fully impacts the PER of each of the pixels.

FIG. 8C is a schematic representation, viewed from above, of an optical wavelength-based light routing device comprising an arrangement formed by the spatial repetition of basic optical routers 80xy, whose basic routing pattern 80xy is in 4×4 format (for reasons of space in the figure, again, only a single basic router 80xy is shown, but ellipses indicate the spatial repetition of this basic router in the X direction and in the Y direction). The device comprises pairs of elementary (quaternary) routers 80a, 80b, 80c, and 80d identical to the elementary router 80 of FIG. 8A but which are placed two-by-two in mirror image of each other, both in the X direction and in the perpendicular Y direction, in accordance with embodiments of the invention. The basic routing pattern 80xy′ of the basic optical router thus obtained comprises sixteen optical output areas, associated with sixteen respective pixels of the underlying pixel matrix. And it is symmetrized bidirectionally, i.e., both in the X direction and in the perpendicular Y direction. Indeed, mirroring the four quaternary elementary routers 80a, 80b, 80c, and 80d in the X direction and in the Y direction gives the basic optical router 80xy symmetry in both the X and Y directions. In other words, the basic optical router 60xy is symmetrical in both the X direction and the Y direction.

Comparing the diagram in FIG. 8C with that in FIG. 8B, it can be observed that in the router 80xy in FIG. 8C there are optical output areas of the bilaterally symmetrized basic routing pattern 80xy′ that are associated with pixels dedicated to detecting light at the same wavelength, and which are contiguous in the X direction and/or the Y direction within said symmetrized basic routing pattern 80xy′.

Advantageously, each pixel of the optoelectronic detection device according to FIG. 8C is contiguous with at least one other pixel dedicated to detecting light having the same wavelength as itself (except for the pixels associated with the optical output areas at the four corners of the base pattern 80xy, whose associated pixels are dedicated to detecting wavelengths corresponding to green in the example shown).

Furthermore, by extrapolating the repetition of the basic routing pattern 80xy′ symmetrical in both the X and Y directions, it can be noted that each pixel of the optoelectronic detection device will be contiguous with at least one other pixel dedicated to detecting light having the same polarization as itself. This optimal result also stems, as for the basic router 80xy shown in FIG. 8D, from the fact that the elementary routing pattern 80′ is regular, i.e., from the fact that it is a pattern having a square format, of the 2×2 type in this example.

All these contiguities improve the PER by mitigating the effect of the inherent reciprocal coupling between adjacent pixels in the X direction and in the Y direction.

The example of an optical wavelength router considered above with reference to FIG. 8A, FIG. 8B, and FIG. 8C also provides an opportunity to generalize here the concept of the direction of optical routing of light in an elementary optical router.

Until this point, each example of an optical router given in this description and shown in the figures has only considered the case of a single direction of light routing within the elementary optical router of an optical light routing device. This is because the various embodiments presented so far relate to elementary optical routers formed from one or more binary optical routers, combined where appropriate by being aligned perpendicular to the direction of light routing. However, in a binary optical router, the light routing rules are always the same, and are also binary for each binary router comprising the elementary optical router: light that does not have the optical characteristic (polarization or wavelength) to the detection of which one of the two pixels associated with the two respective optical output areas is dedicated, is deflected so as to move away from the optical output area associated with that pixel and to be directed toward the center of the optical output area associated with the other pixel, and vice versa. However, this does not limit the possible embodiments of the invention. Indeed, particularly in the case of an optical wavelength-based router, any other routing scheme may include more sophisticated optical routing rules, depending on the specific characteristics of each application, and in particular depending on the sorting (i.e., discrimination) to be obtained at the router output between the different wavelengths considered, as well as depending on the number of pixels available, i.e., also depending on the number of optical output areas available to perform this sorting.

FIG. 9A, FIG. 9B, and FIG. 9C are schematic representations illustrating different possible optical routing rules for the light routing plan in the 2×2 wavelength routing pattern of FIG. 8A, which is shown in top view in these figures. These different wavelength-based light routing rules all relate to the same spatial configuration of the four optical output zones 81, 82, 83, and 84. They apply to the three wavelengths that are sorted by the optical router 80, namely green, red, and blue, respectively. In that sense, it comes to say that FIG. 9A, FIG. 9B, and FIG. 9C illustrate the routing rules for incident light at the green wavelength, the red wavelength, and the blue wavelength, respectively.

In FIG. 9A, FIG. 9B, and FIG. 9C, thick white arrows show the direction and sense of light deflection caused by the metasurface that implements the elementary router 80, in each case for green light, red light, and blue light, respectively. Thus, in these examples:
In FIG. 9A: incident light at the green wavelength is deflected away from the optical output area 81 associated with a pixel dedicated to red detection and away from the optical output area 84 associated with a pixel dedicated to blue detection, to be directed toward the optical output areas 82 and 83 associated with pixels dedicated to green detection, as shown by the thick white arrows in this figure;
In FIG. 9B: incident light at the red wavelength is deflected away from the optical output area 82 and the optical output area 83, which are associated with pixels dedicated to green detection, as well as away from the optical output area 84, which is associated with a pixel dedicated to blue detection, to be directed toward the optical output area 81 associated with a pixel dedicated to red detection, as shown by the thick white arrows in this figure; and, finally
In FIG. 9C: incident light at the blue wavelength is deflected away from optical output area 82 and optical output area 83, which are associated with pixels dedicated to green detection, as well as away from optical output area 81, which is associated with a pixel dedicated to red detection, to be directed toward the optical output area 84 associated with a pixel dedicated to blue detection, as shown by the thick white arrows in this figure.

The skilled person will appreciate that the principle of symmetrization of the basic routing pattern remains compatible with each of the routing plans described above with reference to the diagrams in FIG. 9A, FIG. 9B, and FIG. 9C, as well as others, particularly in the case of optical wavelength-based routers having a topology other than that of router 80 illustrated in FIG. 8A. In fact, since mirroring two elementary optical routers in the X direction and/or in the Y direction creates spatial contiguity between two adjacent pixels that are dedicated to detecting light with the same optical characteristic (namely wavelength in these non-limiting examples), the effect of reciprocal coupling between adjacent pixels, which is inherent in any photodetector array, is attenuated, and the PER of the pixels concerned is improved.

The rules of optical routing of light at different wavelengths in FIG. 9A, FIG. 9B, and FIG. 9C also illustrate why it would be erroneous to limit the embodiments by considering that the elementary optical routers mirrored to each other in a symmetrical basic optical router should be arranged side by side along “the” direction of light routing. Indeed, on the one hand, there may be several light routing directions in the same elementary optical router, as illustrated in FIG. 9A, FIG. 9B, and FIG. 9C for the elementary router 80 of FIG. 8A. On the other hand, a light routing direction within an elementary optical router may be a diagonal direction between the X and Y directions along which pairs of elementary optical routers may be juxtaposed (i.e., placed side-by-side) in mirror image of each other to form a basic optical router that is symetrized along one and/or the other of these X and Y directions. Such diagonal routing directions are shown, for example, in FIG. 9B and FIG. 9C with regard to the routing of light at red and blue wavelengths, respectively. The concept of the “routing direction” of light is therefore sometimes too complex, in certain applications and/or certain modes of implementation, to systematically refer, literally, to one optical routing direction of light in order to define the arrangement of the elementary optical routers that are combined in a symmetrized basic optical router according to the teaching of the invention.

That being said, routing along a diagonal direction between the X and Y directions can, technically, be broken down into one component along the X direction and another component along the Y direction. This is why, in particular, the technical effect associated with mirroring the elementary optical routers in the X direction and/or in the Y direction when they are combined in a basic optical router symmetrized according to the teaching of the invention always attenuates the effect of reciprocal coupling between adjacent pixels in the said X and Y directions. The improvement in PER may vary depending on the implementation modes and applications, but it is always a reality.

Furthermore, as the person skilled in the art can appreciate from the description, from the binary elementary pattern 30 in FIG. 3A, from the quaternary elementary pattern 60 in FIG. 6A, and from the senary elementary pattern 70 in FIG. 7A, an optical routing direction of polarized light will often be the X direction or the Y direction, since it corresponds to a direction in which the two pixels associated with the respective optical output areas of a binary routing pattern arranged to sort light as a function of only two values or states of the incident light in an elementary optical router are arranged side by side. In all these applications, in particular, the principle of symmetrizing the basic routing pattern by mirroring, two-by-two, pairs of elementary optical routers along the X direction and/or along the Y direction, gives appreciable results in terms of PER improvement for the associated pixels of the underlying photodetector array.

The present invention has been described and illustrated in this detailed description and in the accompanying drawings in possible embodiments. However, the present invention is not limited to the embodiments presented. Other variants and embodiments may be deduced and implemented by those skilled in the art upon reading this description and the accompanying drawings.

In the claims, the terms “comprising” or “including” do not exclude other elements or steps. The various features presented and/or claimed may be advantageously combined. Their presence in the description or in different dependent claims does not exclude this possibility. The reference signs indicated in parentheses should not be understood as limiting the scope of the invention.

### LIST OF DOCUMENTS CITED

### Patent Documents

WO2023275032A1
EP4390343 A1

### Non-patent Literature

“Metasurface-based polarization color routers”, par Xiujuan Zou, Guangxing Gong, Yu Lin, Boyan Fu, Shuming Wang, Shining Zhu, et Zhenlin Wang, in the journal Optics and Lasers in Engineering, Volume 163, Avril 2023, 107472, ISSN 0143-8166 (https://doi.org/10.1016/j.optlaseng.2022.107472).
“Efficient polarization beam splitter pixels based on a dielectric metasurface” by M. Khorasaninejad, W. Zhu, and K. B. Crozier, Optica Vol. 2, Issue 4, pp. 376-382, 2015 (https://doi.org/10.1364/OPTICA.2.000376).
“Efficient polarization beam splitter pixels based on a dielectric metasurface”, by Shuwen Wei, Zhenyu Yang, and Ming Zhao, Optics Letters 2017, Vol. 42, Issue 8, pp. 1580-1583, (https://doi.org/10.1364/OL.42.001580).

1. An optoelectronic detector, comprising:
a matrix of elementary photodetectors or pixels arranged in rows extending in a first direction and in columns extending in a second direction, different from said first direction, said first direction and second direction defining the plane of a surface of the optoelectronic detector that is sensitive to incident light,
a device of pixel-level polarization or wavelength routing of the incident light, which is formed above the array of photodetectors,
wherein:
the optical light routing device comprises one or more basic routers, each having an identical basic routing pattern,
the basic router(s) being arranged above the photodetector array, as in such a way that the basic routing pattern is repeated spatially in the first direction and/or in the second direction to cover all or part of said array, and
the basic routing pattern being symmetrical in the first direction and/or in the second direction,
each basic router comprises at least two elementary routers, each having an optical input zone and several optical output zones,
the elementary routers being adjacent two-by-two along the first direction and/or along the second direction, and
the elementary routers each having an identical elementary routing pattern of format N×M, where N and M are integers greater than one, at least one of which is strictly greater than one, said numbers N and M denoting the number of optical output zones of the elementary router that are adjacent to each other two-by-two, as the case may be, in the first direction and in the second direction, respectively,
each elementary router is adapted to sort at its output by optical routing, i.e., by selectively diverting the light received at the optical input area of said elementary router to one of the optical output areas of said elementary router as a function of its polarization or wavelength, the optical output areas of said elementary router each being operatively coupled to a respective associated pixel of the underlying photodetector array which is dedicated, alone or with other similar pixels, to detecting an incident light flux with a determined polarization or at a determined wavelength,
at least two elementary routers that are adjacent in the first direction or in the second direction within a basic router are arranged such that their respective elementary routing patterns are mirrored with respect to each other in said direction, so that one or more pixels associated with output areas of one of said elementary routers and one or more pixels associated with output areas of the other of said elementary routers, which are dedicated to detecting incident light flux with the same polarization state or at the same wavelength, are contiguous along said direction.

2. The optoelectronic detector according to claim 1, wherein the optical light routing device is a polarization-based optical routing device, and wherein:
an elementary router comprises one or more binary routers each having two respective optical output zones,
the two optical output zones of the binary router being adjacent in the first direction or in the second direction, and
the binary router having a binary routing pattern of format 2×1 or 1×2, respectively,
each binary router is adapted to sort at its output by optical routing, i.e., by selective optical deflection toward one of the two optical output zones of said binary router, the incident light received at the optical input zone of the elementary router as a function of its polarization among two respective crossed polarization states.

3. The optoelectronic detector according to claim 2, wherein:
at least one binary router of the elementary router is designed to sort the incident light received at the optical input area of said elementary router by optical routing as a function of the polarization of said light among pairs of linear polarization states that are orthogonal to each other, for example, linear polarizations at 0° and 90°, respectively, or linear polarizations at 45° and 135°, respectively.

4. The optoelectronic detector according to claim 3, wherein:
the elementary routing pattern of a given elementary router is a 2×2 routing pattern with four optical output zones,
said elementary router comprising two binary routers,
said binary routers each being designed to sort the incident light received at the optical input zone of the elementary router by optical routing as a function of the polarization of said light among respective pairs of linear polarization states that are orthogonal to each other, namely, for example, linear polarizations at 0° and 90° for one of said binary routers, and linear polarizations at 45° and 135° for the other of said binary routers.

5. The optoelectronic detector according to claim 4, wherein:
the basic routing pattern of the basic router is a 4×2 routing pattern comprising eight optical output zones,
said basic router comprising two elementary routers with an elementary routing pattern of 2×2 format, each comprising two binary routers with a binary routing pattern of 2×1 format or 1×2 format, which are adjacent in the first direction or in the second direction, respectively,
said elementary routers being adjacent in the first direction or in the second direction within the basic router and arranged such that their respective elementary routing patterns are mirrored with respect to each other in said direction, so that one or more pixels associated with output areas of one of said elementary routers and one or more pixels associated with output areas of the other of said elementary routers, which are dedicated to detecting light flux with the same linear polarization state, are contiguous along said direction.

6. The optoelectronic detector according to claim 2, wherein:
at least one binary router of an elementary router is adapted to sort the incident light received at the optical input area of said elementary router by optical routing as a function of the polarization of said light among the left circular and right circular polarization states.

7. The optoelectronic detector according to claim 6, wherein:
the basic routing pattern of a basic router is a 3×2 or 2×3 routing pattern with six optical output zones,
said elementary router comprising three binary routers,
said binary routers each being adapted to sort the incident light received at the input zone of said binary router by optical routing as a function of the polarization of said light among respective pairs of orthogonal polarization states, namely the orthogonal linear polarization states at 0° and 90° for a first of said binary routers, the orthogonal linear polarization states at 45° and 135° for a second of said binary routers, and the left circular and right circular polarization states for a third of said binary routers.

8. The optoelectronic detector according to claim 7, wherein:
the basic routing pattern of a basic router is a 4×3 or 3×4 routing pattern comprising twelve optical output zones,
said unitary router comprising two elementary routers with a 2×3 or 3×2 routing pattern, each comprising three binary routers with a 2×1 or 1×2 routing pattern,
said elementary routers being adjacent in the first direction or in the second direction within the basic router and arranged such that their respective elementary routing patterns are mirrored with respect to each other in said direction, so that one or more pixels associated with optical output areas of one of said elementary routers and one or more pixels associated with optical output areas of the other of said elementary routers, which are dedicated to detecting incident light flux with the same polarization state, are contiguous along said direction.

9. The optoelectronic detector according to claim 6, wherein:
the basic routing pattern of a basic router is a 4×6 format routing pattern comprising twenty-four optical output zones,
said basic router comprising four elementary routers with a routing pattern of 2×3 or 3×2 format, each comprising three binary routers with an elementary routing pattern of 2×1 or 1×2 format,
said elementary routers being adjacent in pairs along the first direction and along the second direction within the basic router and being arranged such that their respective elementary routing patterns are arranged in pairs mirroring each other along said first direction and along said second direction, so that one or more pixels associated with optical output areas of one of said elementary routers and one or more pixels associated with optical output areas of the other of said elementary routers, which are dedicated to detecting the incident light flux with the same polarization state, are contiguous along said direction.

10. The optoelectronic detector according to claim 1, wherein the optical light routing device is a wavelength light routing device, and:
the basic routing pattern of a basic router is a routing pattern comprising at least two optical output zones, each of which is associated with a specific wavelength, for example one of the wavelengths corresponding to the colors red, green, and blue, respectively.

11. The optoelectronic detector according to claim 10, wherein:
the basic routing pattern of a basic router is a 2×2 routing pattern comprising four optical output areas, of which:
one optical output area is operatively coupled to a pixel of the underlying photodetector array that is dedicated to detecting light at the wavelength corresponding to the red color, and
two other optical output areas that are diametrically opposed to each other and are respectively operatively coupled to two pixels of the underlying photodetector array that are dedicated to detecting light at the wavelength corresponding to the color green, the other optical output zone is operatively coupled to a pixel of the underlying photodetector array that is dedicated to detecting light at the wavelength corresponding to the blue color.

12. The optoelectronic detector according to claim 8, wherein:
the basic routing pattern of a basic router is a 4×4 format routing pattern comprising sixteen optical output zones,
said basic router comprising four elementary routers, each with a 2×2 routing pattern, which are adjacent in pairs in the first direction and in the second direction within the basic router and arranged such that their respective elementary routing patterns are arranged in pairs mirroring each other along said first direction and along said second direction.

13. The optoelectronic detector according to claim 1, wherein the polarization or wavelength optical routing device is formed from an optical routing meta-structure designed to sort the output of elementary routers by optical routing, i.e., to selectively deflect the incident light received at the input of the meta-structure to one or the other of the optical output areas of said elementary routers, as a function of its polarization state or wavelength.

14. The optoelectronic detector according to claim 1, wherein basic routers repeated in the optical routing device are formed side-by-side and without spacing, along the first direction or along the second direction.

15. A CMOS image sensor comprising an optoelectronic detector according to claim 1.
